(19) United States
(12) Patent Application Publication
(10) Pub. No.: US 2016/0371363 A1
(43) Pub. Date: Dec. 22, 2016

(54) TIME SERIES DATA MANAGEMENT METHOD AND TIME SERIES DATA MANAGEMENT SYSTEM

(71) Applicant: Hitachi, Ltd., Tokyo (JP)

(72) Inventors: Keiro MURO, Tokyo (JP); Yasushi MIYATA, Tokyo (JP); Hiroyasu NISHIYAMA, Tokyo (JP)

(73) Assignee: HITACHI, LTD., Tokyo (JP)

(21) Appl. No.: 15/122,191

(22) PCT Filed: Mar. 26, 2014
(86) PCT No.: PCT/JP2014/058616

§ 371 Date: Aug. 29, 2016

(51) Int. Cl. G06F 17/30; G01D 9/28

(52) U.S. Cl. CPC G06F 17/30598; G06F 17/30551; G01D 9/28

(57) ABSTRACT

A time-series data management method for generating a histogram from time-series data using a computer provided with a processor and a storage device, the computer storing the time-series data including a time of day and a value in the storage device, storing section information including a start time, an end time, and an identifier of the time-series data in the storage device, generating the histogram from the time-series data corresponding to the section information and storing the generated histogram in the storage device, accepting a section to be searched and selecting the histogram associated with the section to be searched, and combining the selected histograms and generating a histogram for the section to be searched

### BACKGROUND

The present invention relates to a time series data management system and a time series data management method by which time series data such as temperature, power usage amount, and vibrational stress of a device is acquired continuously over time.

In recent years, with the advance of sensing technologies such as radio frequency identification (RFID) and the Global Positioning System (GPS), it has become possible to acquire various sensor data from the real world such as from power plants, factories, and offices, and there is an increasing number of examples of these technologies being used in businesses.

Various examples of applications are on the verge of being put to practical use, such examples including: smart grids in which the amount of power used by each household is acquired by a meter and the amount of power needed in the future is estimated according to this usage state so as to control the optimal amount of power to generate; preventative maintenance of devices in which operation information such as the number of revolutions of a motor or pressure is acquired from devices and equipment of a plant or factory, and anomalies or malfunctions in the devices are detected in advance according to the values of the operating information or changes in such values; and sensor-based design in which the amount of damage in relation to metal fatigue is estimated from the stress oscillation distribution and the fatigue life is calculated, thereby achieving an optimal design.

In sensor-based design, time series data acquired by multiple sensors is processed. Generally, sensor time series data is defined as an aggregate of time and measurement values present at the features to be measured and each sensor arranged at the features. One method to perform statistical analysis of a large amount of time series data generated by providing multiple sensors is to use a histogram obtained by categorizing the measured data into a plurality of ranges and aggregating the frequency of measured values in each of the ranges.

By generating a histogram of representative intervals for vibrational stress in a device, for example, it is possible to acquire the distribution of stress on the device. The number of repeated uses until metal fracture in relation to each stress value is calculated from a metal fatigue curve, and by comparing the number of repeated uses to the stress distribution, it is possible to estimate the metal fatigue life of the device.

A histogram of measured values is generated for intervals where the device is in normal operation, this histogram is compared with a histogram of recent measured values or recent intervals, and by calculating the degree of similarity therebetween, it is possible to detect that the device is not in normal operation, that is, to detect an anomaly or a sign that an anomaly is about to occur.

By generating a histogram of the amount of power use at a residence and comparing the histogram with a plurality of classification axes such as residences, seasons, or time periods, it is possible to select residence characteristics such as whether the household tends be conscious of power usage, seasonal characteristics such as air conditioner usage during the four seasons, and lifestyle such as hours of sleep, hours during which the residents are not at home, and cooking times. By such characteristics, it is possible to provide advice or the like pertaining to energy savings.

When performing such time series analysis, there is a need to perform analysis by trial and error by modifying the types and intervals of time series data according to changes in the environment or the purposes of analysis. In order to increase efficiency of time series analysis by trial and error in this manner, it is preferable that information shared by a plurality of types of time series analysis be generated in advance.

Meanwhile, in areas such as supply chain management (SCM), a method is known in which, by classifying data in steps along multidimensional axes and aggregating the data in advance for each category, it is possible to increase the speed of aggregation at a given axis, and to increase the efficiency by which the cause of an anomaly is determined (see JP 2002-183178 A, JP 2005-316692 A, and JP 2009-129031 A). Such an analysis method is referred to as online analytical processing (OLAP). OLAP will be explained in general with reference to FIG. 26. The table 2601 shown in FIG. 26 is an example of a table from which analysis is to be performed, and is referred to as a fact table. In OLAP, when recording data, a combination by which an aggregation pattern can be acquired is selected to perform aggregation according to classification axes defined in advance by the designer, and an OLAP cube shown in table 2602 is generated. An array V (2611) of the fact table of table 2601 is, for example, the total product sales, and has two classification axes: arrays S1 (2621) and S2 (2631). Examples of S1 and S2 include sale dates, product types, and the stores where the sales were made.

The classification axes have a hierarchical structure in which they are further subdivided by day, week, or month; by product type or category; by store location; or by region. If the classification axes S1 and S2 of the table 2601 acquire either values of {S11, S12} or {S21, S22}, and S11 and S12, and S21 and S22 are grouped, then by calculating in advance nine ((2+1)×(2+1)) different aggregation patterns, OLAP increases the speed of aggregation at a given classification axis.

### SUMMARY

In order to increase efficiency of time series analysis, it becomes necessary to generate in advance information shared by a plurality of types of time series analyses. However, if analyzing the sensor time series data, which is handled by the present invention, by the conventional OLAP, this results in the following two problems.

The first problem is that the amount of sensor time series data is larger than in OLAP, and that it is unrealistic to perform aggregation for all possible combinations. Classifying as is measured values generated every 10 ms for a stress oscillation chronology where the sampling frequency is 100 Hz, for example, is unrealistic due to constraints of data capacity and processing time.

A second problem is that it is difficult to partition time series data into predetermined intervals. The partitioning of intervals is itself to be analyzed, and intervals partitioned according to a first analysis do not necessarily match intervals partitioned according to a second analysis. If a lifestyle scene is to be partitioned into sleep hours, cooking hours, bathing hours, and the like, for example, then the partitions might differ for each analysis method. Additionally, if residences are to be classified into those that are conscious of power usage and those that are not, then the elements in the residence aggregate can differ for each method of analysis.

In JP 2009-129031 A, data is handled as interval data having a start time and an end time, thereby providing a data analysis method by which time series is handled with ease. However, the intervals in JP 2009-129031 A is predetermined as data such as hospitalization period and are established information, which does not solve the second problem.

The present invention takes into account the above-mentioned problems, and an object thereof is to quickly output a histogram for an aggregate of desired intervals and features from time series data.

A representative aspect of the present disclosure is as follows. A time series data management method by which a histogram is generated from time series data in a computer that includes a processor and a storage device, the method comprising: a first step in which the computer stores in the storage device the time series data including a time and a value; a second step in which the computer stores in the storage device interval information including a start time, an end time, and an identifier of the time series data; a third step in which the computer generates the histogram from the time series data corresponding to the interval information and accumulates the histogram in the storage device; a fourth step in which the computer receives an interval to be searched; and a fifth step in which the computer selects the histograms relating to the interval to be searched, combines the selected histograms, and generates a histogram of the interval to be searched.

According to the present invention it is possible to quickly generate a histogram for an aggregate of desired intervals and features from accumulated time series data.

### BRIEF DESCRIPTION OF THE DRAWINGS

FIG. 1 is a block diagram showing an example of a configuration of time series analysis system according to a first embodiment of this invention.

FIG. 2 is a block diagram showing an example of a configuration of time series analysis module according to the first embodiment of this invention.

FIG. 3A is an XML script showing an example of feature data according to the first embodiment of this invention.

FIG. 3B is an attribute management table 301 that manages attributes of the feature data according to the first embodiment of this invention.

FIG. 3C is a correlation management table 302 that manages correlations between feature data according to the first embodiment of this invention.

FIG. 4 shows the structure of the sensor data according to the first embodiment of this invention.

FIG. 5A indicates the structure of time series data according to the first embodiment of this invention.

FIG. 5B indicates the structure of time series data according to the first embodiment of this invention.

FIG. 5C indicates the structure of time series data according to the first embodiment of this invention.

FIG. 6 shows the structure of the interval data according to the first embodiment of this invention.

FIG. 7 shows the relationship between the interval data 111 and the time series data according to the first embodiment of this invention.

FIG. 8 shows the structure of the partial histogram data according to the first embodiment of this invention.

FIG. 9 shows the relationship between feature data 108, and the interval data and partial histogram data according to the first embodiment of this invention.

FIG. 10 shows the relationship between state data and the partial histogram data according to a second embodiment of this invention.

FIG. 11 shows the relationship between the feature aggregate data, and the state data and partial histogram data overlapping features according to a third embodiment of this invention.

FIG. 12 shows an example of a process performed in the similar interval combining function according to the first embodiment of this invention.

FIG. 13 is a flowchart showing an example of the process performed in the partial interval histogram generation function according to the first embodiment of this invention.

FIG. 14 is a flow chart showing an example of a process of calculating the second unit interval in the similar interval combining function according to the first embodiment of this invention.

FIG. 15 shows an example of the process performed in the per-interval histogram combination function according to the first embodiment of this invention.

FIG. 16 shows a flowchart of an example of the process performed in the per-interval histogram combination function according to the first embodiment of this invention.

FIG. 17 shows an example of a process of the lifespan estimation function according to the first embodiment of this invention.

FIG. 18 is a flowchart for calculating the probability distribution P(A) of states according to the first embodiment of this invention.

FIG. 19 is a block diagram showing the partial interval histogram generation function and the interval histogram generation function according to the first embodiment of this invention.

FIG. 20 is a flowchart showing Embodiment 2 of the present invention, and showing an example of the process performed in the partial interval histogram generation function according to a second embodiment of this invention.

FIG. 21 is a flowchart showing an example of the process of generating a histogram using the partial histograms of the states according to the second embodiment of this invention.

FIG. 22 is a block diagram showing a configuration of a time series data analysis system that distributes and accumulates the time series data across a plurality of servers according to a fourth embodiment of this invention.

FIG. 23 shows an example of queries and response data when searching time series data according to the fourth embodiment of this invention.

FIG. 24 shows an example of a query issued by the analysis terminal in order to acquire a histogram of time series data, and returned results of the query according to the fourth embodiment of this invention.

FIG. 25A shows XML expressions of the partial histogram data.

FIG. 25B is a graph showing the relationship between the measurement value and frequency in the partial histogram data.

FIG. 26 is for describing the process of the OLAP.

FIG. 27A is for describing the process of the histogram addition/subtraction function according to the first embodiment of this invention.

FIG. 27B is for describing the process of the histogram addition/subtraction function according to the first embodiment of this invention.

FIG. 28A shows a process of a second implementation performed in the similar interval combining function according to the first embodiment of this invention.

FIG. 28B shows a process of a second implementation performed in the similar interval combining function according to the first embodiment of this invention.

FIG. 29 is a flowchart of a process performed in a second implementation of the similar interval combining function according to the first embodiment of this invention.

FIG. 30 is an example of a management structure of the state data according to the first embodiment of this invention.

### DETAILED DESCRIPTION OF EMBODIMENTS

Below, an embodiment of the present invention will be explained with reference to affixed drawings.

### Embodiment 1

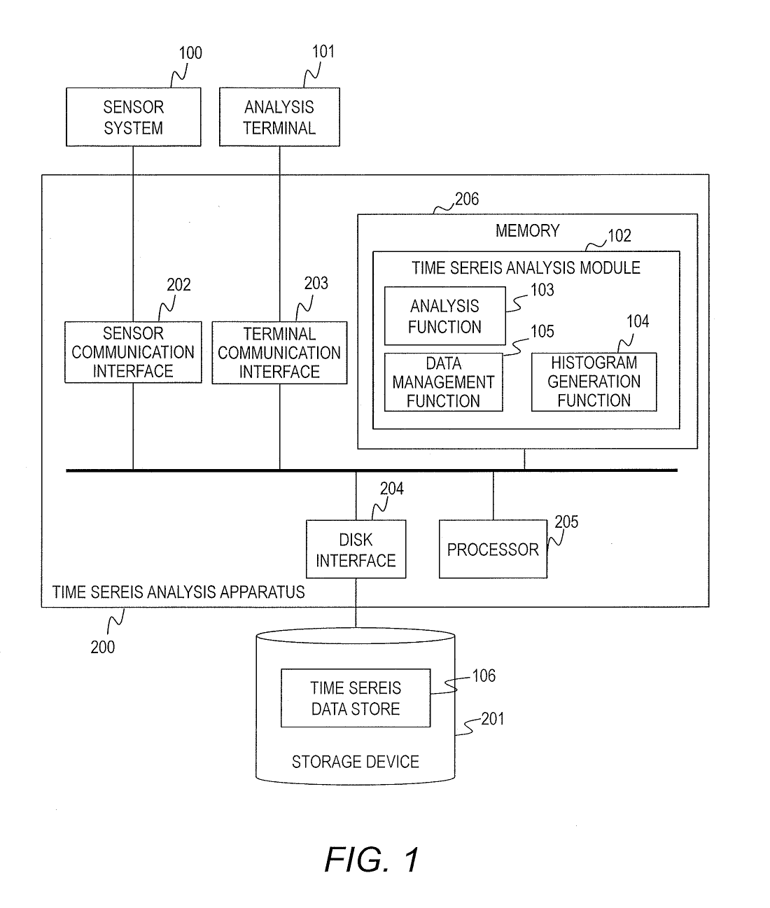

FIG. 1 is a block diagram showing an example of a configuration of time series analysis system to which the present invention is applied. A time series analysis system of Embodiment 1 is comprised of a sensor system 100 that gathers real world measurement values using sensors and transmits the values as time series data, an analysis terminal 101 that issues search queries on the time series data and receives search results, a time series analysis apparatus 200 that manages the time series data and performs an analysis process, and a storage device 201 that stores a time series data store 106, where various types of time series data to be described later are stored, and a time series analysis module 102.

The time series analysis apparatus 200 has a processor 205, a memory 206, a sensor communication interface 202, a terminal communication interface 203, and a disk interface 204.

The chronology analysis module 102 has a data management function 105, a histogram generation function 104, and an analysis function 103, and programs in the chronology analysis module 102 are loaded from the storage device 201 to the memory 206 and executed by the processor 205.

The time series analysis apparatus 200 receives time series data from the sensor system 100 through the sensor communication interface 202, and using the data management function 105 stores the time series data in the storage device through the disk interface 204. The sensor system 100 includes a plurality of sensors and generates time series data.

A histogram is generated from the time series data by the histogram generation function 104 of the chronology analysis module 102, and the data management function 105 stores the histogram in the storage device through the disk interface 204.

The time series analysis apparatus 200 also receives search queries for the histogram or time series data from the analysis terminal 101 through the terminal communication interface 203, searches or receives the histogram by the histogram generation function 104 and the data management function 105, and responds to the analysis terminal 101. The time series analysis apparatus 200 also performs various types of analysis processes such as lifespan estimation or singularity detection by the analysis function 103, which uses the histogram generation function 104. The chronology analysis module 102 and the respective functional units including the analysis function 103, histogram generation function 104, and data management function 105 are loaded into the memory 206 as programs.

The processor 205 operates as a functional unit that provides prescribed functions by executing processes according to programs in respective functional units. The processor 205 functions as the chronology analysis module 102 by performing processes according to a chronology analysis program, for example. The same applies for other programs. Additionally, the processor 205 also operates as functional units providing, respectively, functions of a plurality of processes executed by respective programs. The computer and the computer system are a device and system including these functional units.

Programs, tables, and the like realizing respective functions of the time series analysis apparatus 200 can be stored in a storage device such as the storage device 201, a non-volatile semiconductor memory, a hard disk drive, or a solid state drive (SSD), or in a computer-readable non-transitory data storage medium such as an IC card, an SD card, or a DVD.

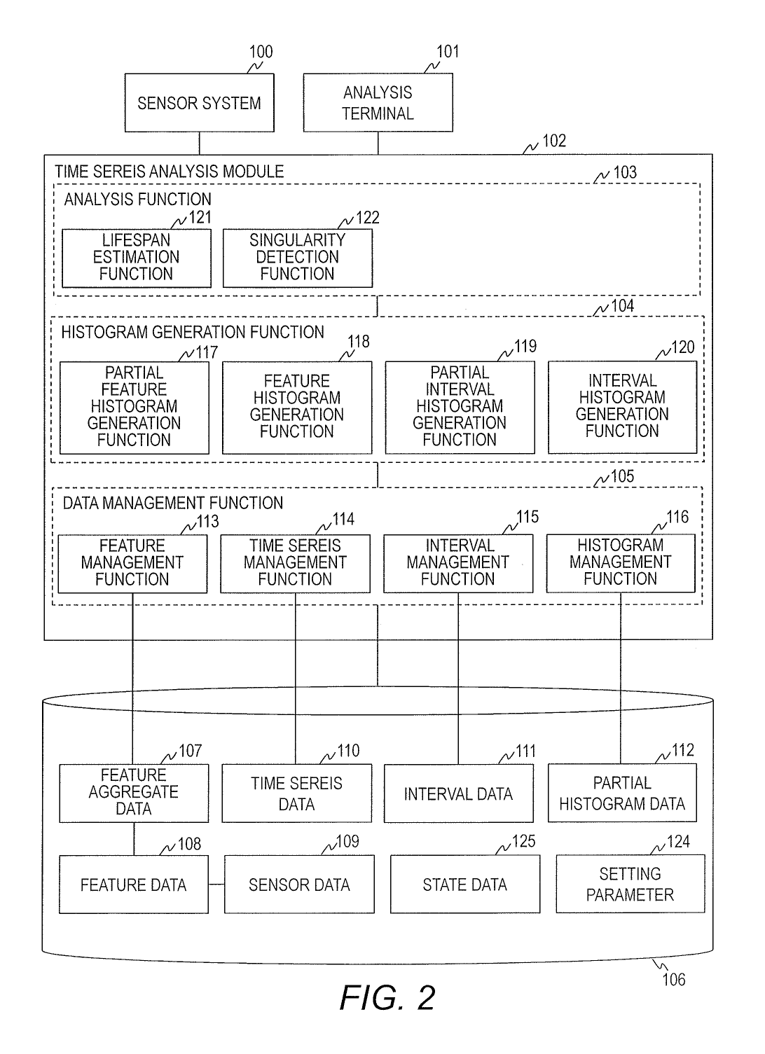

A configuration of the chronology analysis module 102 of the present invention will be described with reference to FIG. 2. The chronology analysis module 102 is comprised of an analysis function 103, a histogram generation function 104, a data management function 105, and a time series data store 106.

The time series data store 106 is a storage region that stores data handled by the chronology analysis module 102, and stores feature aggregate data 107, feature data 108, sensor data 109, time series data 110, interval data 111, partial histogram data 112, setting parameters 124, and state data 125. In Embodiment 1, an example was shown in which the time series data store 106 is stored in the storage device 201, which is coupled to the time series analysis device 100, but the time series data store 106 may be stored in a storage device coupled to the time series analysis apparatus 200 through a network.

The data management function 105 of the chronology analysis module 102 provides management functions that include storing, updating, or searching data stored in the time series data store 106. The data management function 105 is comprised of a feature management function 113 that manages feature aggregate data 107, feature data 108, and sensor data 109; a chronology management function 114 that manages the time series data 110; an interval management function 115 that manages interval data 111; and a histogram management function 116 that manages partial histogram data 112.

The histogram generation function 104 is comprised of a partial interval histogram generation function 119 that generates interval data 111 and partial histogram data 112 from the time series data 110, an interval histogram generation function 120 that receives search requests from the analysis terminal 101 and generates histograms according to the searched interval from the partial histogram data 112, a partial feature histogram generation function 117 that generates feature aggregate data 107 and partial histogram data 112 from the feature data 108 and the time series data 110, and a feature histogram generation function 118 that receives search requests from the analysis terminal 101 and generates a histogram for the feature aggregate to be searched from the partial histogram data 112.

The analysis function 103 is a library of analysis algorithms using the histogram generation function 104, and is, for example, comprised of a lifespan estimation function 121 that estimates the metal fatigue life from an oscillation stress histogram and a metal fatigue curve, and a singularity detection function 122 that detects a singularity by performing a similarity comparison of the histogram to recently measured values.

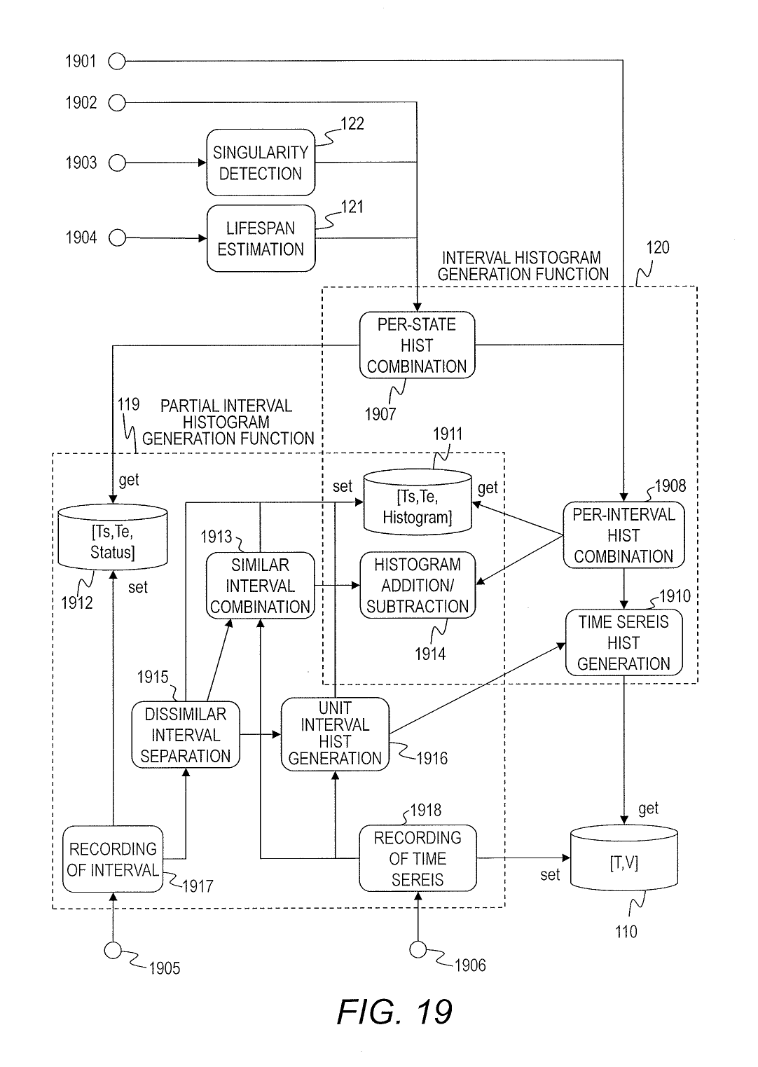

FIG. 19 is a block diagram showing the partial interval histogram generation function 119 and the interval histogram generation function 120. Detailed function blocks of the partial interval histogram generation function 119 and the interval histogram generation function 120 in the histogram generation function 104, relationships with adjacent function blocks, and the process flow will be described with reference to FIG. 19.

The partial interval histogram generation function 119 has an interval recording interface 1905 and a chronology recording interface 1906, and is comprised of an interval recording function 1917, a unit interval histogram generation function 1916, a similar interval combining function 1913, a dissimilar interval separation function 1915, and a histogram addition/subtraction function 1914.

The interval histogram generation function 120 has a per-interval histogram combination interface 1901 and a per-state histogram combination interface 1902, and is comprised of a per-state histogram combination function 1907, a per-interval histogram combination function 1908, a chronology histogram generation function 1910, and a histogram addition/subtraction function 1914. The histogram addition/subtraction function 1914 is shared between the partial interval histogram generation function 119 and the interval histogram generation function 120. The histogram addition/subtraction function 1914 needs to be present in at least one of the partial interval histogram generation function 119 and the interval histogram generation function 120.

The singularity detection function 122 in the analysis function 103 of FIG. 2 has a singularity detection interface 1903, the lifespan estimation function 121 has a lifespan estimation interface 1904, and each uses the per-state histogram combination function 1907.

The purpose of the chronology recording interface 1906 is to receive the time series data 110, which is the aggregate of times and measurement values, as an argument, and to record the time series data 110 in the time series data store 106.

When the sensor system 100 calls the chronology recording interface 1906, a chronology recording function 1918 stores the time series data 110 in the time series data store 106. The unit interval histogram generation function 1916 generates, using the chronology histogram generation function 1910, the partial histogram data 112 for each unit interval of a length stored in advance as a setting parameter 124, and stores the partial histogram data 112 generated in the histogram management table 1911 (histogram management information) where the interval data 111 is stored.

The chronology histogram generation function 1910 has the function of generating a histogram using the time series data 110. The chronology recording function 1918 further combines adjacent similar intervals among histograms of generated unit intervals, and stores the combined intervals in the histogram management table 1911.

The combining of the histograms corresponding to the combining the intervals are performed by the histogram addition/subtraction function 1914.

The purpose of the interval recording interface 1905 is to receive as an argument an aggregate of the interval data 111, which is comprised of state labels such as start times and end times, power generation states, and pause states, and to record the interval data 111 in the time series data store 106.

If the sensor system 100 or analysis terminal 101 calls the interval recording interface 1905, then the interval recording function 1917 stores the interval data 111 in the state interval management table 1912, and the dissimilar interval separation function 1915 partitions interval data 111 into a plurality of dissimilar intervals and stores the intervals in the histogram management table 1911.

The purpose of the per-interval histogram combination interface 1901 is to receive as an argument an aggregate of the intervals represented by the start times and end times, and to acquire histograms of the inputted interval aggregate from the partial histogram data 112 of the time series data store 106.

If the analysis terminal 101 calls the per-interval histogram combination interface 1901, then the per-interval histogram combination function 1908 acquires partial histogram data 112 of intervals encompassed within a time range of the respective intervals in the interval aggregate inputted from the histogram management table 1911, and adds a histogram using the histogram addition/subtraction function 1914. The time series analysis apparatus 100 transmits the added histogram to the analysis terminal 101 as a partial histogram of a designated interval.

If the partial histogram data 112 of the corresponding interval is not present in the histogram management table 1911, the per-interval histogram combination function 1908 generates a histogram for the interval from the time series data 110 using the chronology histogram generation function 1910 and adds the histogram using the histogram addition/subtraction function 1914. The histogram addition/subtraction function 1914 may add other partial histograms to the generated histogram, or generate and combine a plurality of histograms.

The purpose of the per-state histogram combination interface 1902 is to receive as arguments a search range represented by the start time and end time, and the state, and to acquire histograms of the inputted interval aggregate corresponding to the designated state within the search range.

If the analysis terminal 110 calls the per-state histogram combination interface 1902, the per-state histogram combination function 1907 acquires the interval aggregate of the relevant state from a state interval management table 1912 and acquires the target results by calling the per-interval histogram combination interface with the interval aggregate as an argument.

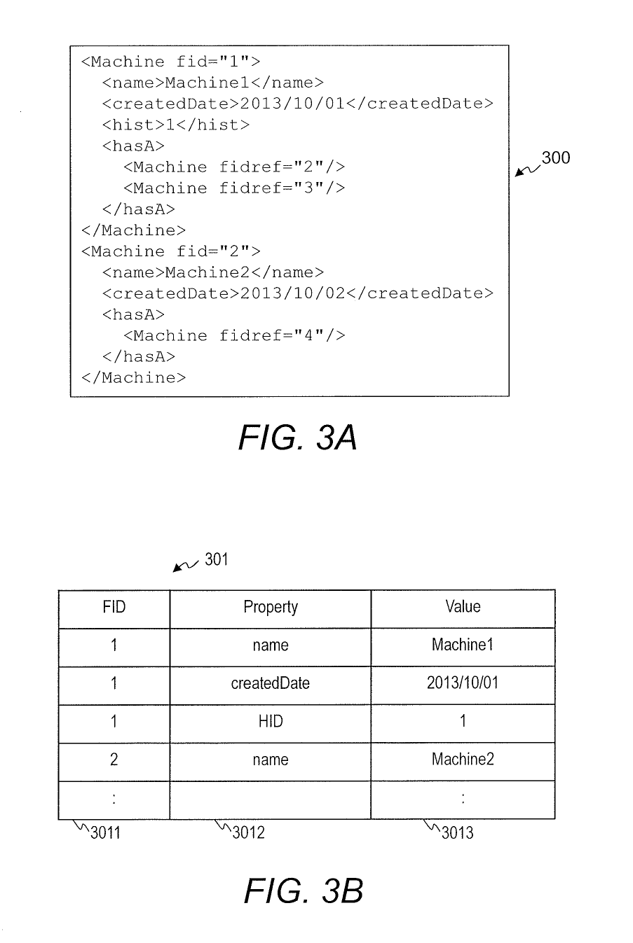

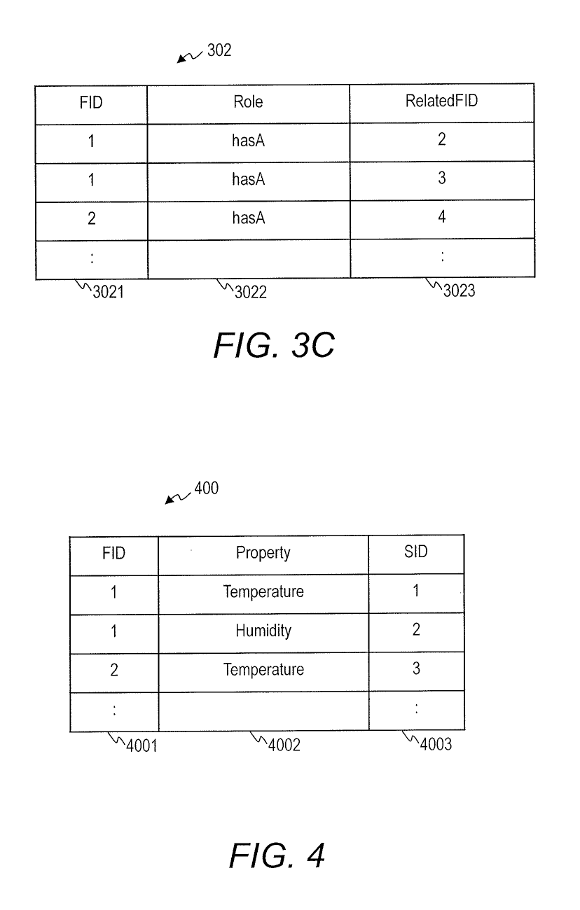

FIGS. 3A, 3B, and 3C show an example of feature data 108. FIG. 3A is an XML script showing an example of feature data 108. FIG. 3B is an attribute management table 301 that manages attributes of the feature data 108. FIG. 3C is a correlation management table 302 that manages correlations between feature data.

The feature data 108, the feature aggregate data 107, and the feature management function 113 will be described with reference to FIGS. 3A to 3C.

Features are items to be measured in the real world such as the mechanical device, residence, and people, and the feature data 108 is data represented on a computer of values acquired from the items to be measured. The feature data 108 can be comprised of hierarchical data. XML 300 in FIG. 3A shows an example of feature data 108 coded in the standard language XML (Extensible Markup Language) for representing the hierarchical data structure of the feature data 108.

The feature data 108 manages FIDs 3011 and 3021, which are identifiers for uniquely identifying the feature data as in FIGS. 3B and 3C; 0 or more pieces of attribute data 3012; and a related FID 3023.

In the example of XML 300 shown in FIG. 3A, as feature data where the FID is “1” and the type is “Machine”, attributes where the name is “Machine1” and the creation date is “2013/10/01”, histogram information where HID=1, HID being an identifier that uniquely identifies partial histogram data, are managed, and features where the FIDs are 2 and 3 are managed as related feature data 108. Also, as feature data where the FID is “2” and the type is “Machine”, attributes where the name is “Machine2” and the creation date is “2013/10/02” is managed, and a feature where the FID is “4” is managed as related feature data 108. FIGS. 3B and 3C also have similar content to FIG. 3A stored in tabular format.

The feature management function 113 of the data management function 105 has the function of recording features, the function of updating attributes of the features, and the feature of setting relations of the features or deleting the features. The feature management function 113 further has the function of inputting as a query the attributes such as the name being “Machine1”, attribute determination conditions such as the creation date being from 2013, and information comprised of a combination thereof, and searching an FID aggregate of the corresponding feature.

The feature management function 113 additionally has the function of inputting as a query a related path such as “temperature sensors of all parts of all devices created since 2013”, and searching an FID aggregate of the corresponding feature. The specification of the related path is defined by a standard language such as XPath, for example. The feature management function additionally has the function of inputting an FID and searching for attributes and relations of the relevant feature.

The feature data 108 should have a structure having information equivalent to XML 300 shown in FIG. 3A. In a relational database management system (RDBMS), for example, a structure may be used that expresses a feature through the combination of tables 301 and 302 shown in FIGS. 3B and 3C. The table 301 manages feature attributes and has an FID 3011, an attribute name property 3012, and an attribute value 3013. The table 302 manages feature attributes and has an FID 3021, a related name role 3022, and a related FID 3023 that is the FID of a related attribute.

The feature aggregate data 107 is managed by including 0 or more features in relation to one feature. An example of a feature aggregate is a component aggregate for a device or a sensor aggregate attached to the components. An appropriate feature aggregate such as an aggregate of devices made by the same manufacturer or having the same manufacturing date, or an aggregate of devices that malfunction frequently may be managed by a similar method.

The sensor data 109 will be described with reference to FIG. 4. FIG. 4 shows the structure of the sensor data 109. The table 400 showing the sensor data 109 manages information concerning which sensor is provided for the feature, and is comprised of an FID 4001 that is an identifier uniquely identifying the feature data 108, an SID 4003 that is an identifier uniquely identifying sensors, and a property 4002 that indicates the type of sensor.

A unit system for measurement values outputted by the sensors and information for the sensors such as ranges may be stored as attributes of the sensor data 109. The feature management function 113 further has the function of inputting as a query the FID 4001 and the type of sensor, and searching the SID 4003 using the sensor data 109.

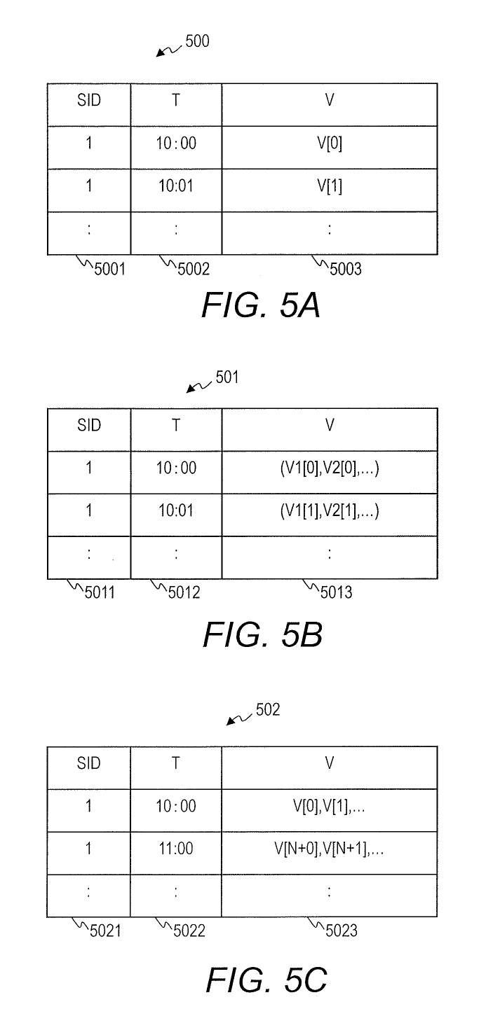

FIGS. 5A, 5B, and 5C indicate the structure of time series data. Below, the time series data 110 and the chronology management function 114 will be described with reference to FIGS. 5A to 5C. The time series data 110 is measurement information measured by sensors in the sensor system 10 and is managed as a combination of the measurement times and measurement values. Examples of three types of structures managing the time series data 110 are shown in tables 500, 501, and 502.

In the table 500 of FIG. 5A, an SID 5001 that is an identifier uniquely identifying the sensor, a measurement time T 5002, and a measurement value V 5003 are managed as a group. In the first row of the table 500, the SID 5001 is 1, the time T 5002 is 10:00, and the measurement value 5003 is V[0]. Here, the number in the brackets in V[0] is an explanatory notation indicating the order of the measurement value in the time direction (chronology).

The time series data 110 may be managed using the table 501 as shown in FIG. 5B. In the table 501, a multivariate chronology that is a plurality of measurement values from a plurality of sensors V1, V2, etc. is managed collectively as the measurement value V. The SID 5011 of the present embodiment is an identifier uniquely identifying a sensor aggregate that is a collection of a plurality of sensors.

The time series data 110 may be managed using the table 502 as shown in FIG. 5C. In the table 502, a partial chronology comprised of measurement values at a plurality of times (5022) is managed collectively as the measurement value V (5023).

The partial chronology may be managed as a chronology block compressed using a well-known or publicly known data compression algorithm such as gzip. The time T (5002, 5012, 5022) indicates the start time of the partial chronology.

In the table 502 shown in FIG. 5C, for example, 3600 one second chronologies totaling 1 hour are managed as one chronology block. The time T 5022 is at 1 hour intervals. The time series data 110 may also be managed as a multivariate partial chronology combining the table 501 of FIG. 5A with the table 502 of FIG. 5B.

The chronology management function 114 has the function of recording time series data 110 indicated by the aggregate of the SIDs (5001, 5011, 5021) uniquely identifying the sensors, the times T (5002, 5012, 5022), and the measurement values V (5003, 5013, 5023).

The chronology management function 114 additionally has the function of inputting as a query an SID that uniquely identifies sensors or an aggregate of SIDs, or an interval that is identified by a start time and end time, and issuing the relevant sensors or partial time series data in the interval as a response.

If the analysis terminal 101 refers to the time series data, then it uses the feature management function 113. The feature management function 113 refers to XML 300 and tables 301 and 302, which are an implementation of feature data 108 and feature aggregate data 107, to acquire the FID of feature data corresponding to the requested attribute or the related path. The feature management function 113 refers to the table 400, which is an implementation of the sensor data 109, to acquire the SID 4003 of the sensor from the corresponding FID 4001, and refers to any one of the tables 500, 501, and 502, which are an implementation of the time series data 110, to acquire the corresponding time series data.

In the present embodiment, an example is illustrated in which the data acquired by the sensor system 100 is used as the time series data 110, but the present invention can be applied to any data comprised of a group of times and values.

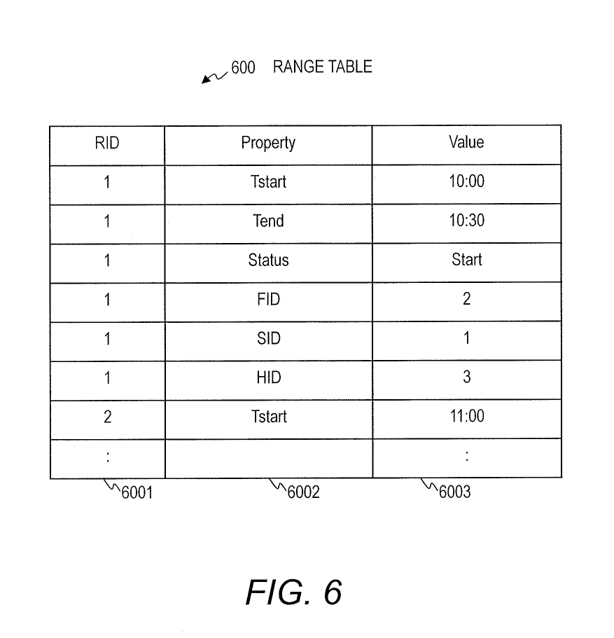

The interval data 111 and the interval management function 115 will be described with reference to FIG. 6. FIG. 6 shows the structure of the interval data 111.

An interval is information designating a time range (period) by a start time and an end time. An example in which the feature is a power generator will be described below. Examples of intervals in the power generator include the pause interval of the power generator, a startup interval, a power generation interval, and a stopping interval. Examples of intervals regarding lifestyle patterns of a residence include an interval during which residents are asleep, an interval during which residents are away from home, an interval during which the residents are cooking, and an interval during which the residents are eating. The interval data 111 expresses intervals on a computer.

An example of a management structure of the interval data 111 is shown in table 600 of FIG. 6. In table 600, the interval data 111 includes an RID 6001 that is an identifier uniquely identifying an interval, a property 6002 that stores attributes, and a value 6003 that stores a value. As an example of attributes, the property 6002 includes a start time Tstart, an end time Tend, and a state label “Status”.

The interval data 111 may further store the FID, which is an identifier for a feature belonging to an interval; the SID, which is an identifier for a sensor (component of sensor system 10) belonging to the interval; or the partial histogram data 112 in the time series data within the interval and the identifier HID thereof.

The interval management function 115 has the function of designating the start time Tstart and end time Tend as necessary information; and any or all of a state “Status”, an identifier FID of a feature, an identifier SID of a sensor, and an identifier HID of partial histogram data 112 as additional information, and recording the interval data 111 in the time series data store 106.

The interval management function 115 additionally has the function of inputting as a query the start time and end time representing the interval to be searched, and the state label, and searching the RID 6001 of all intervals included within the intervals to be searched and that match the state label.

The interval management function 115 also has the function of searching any or all of the start time Tstart, end time Tend, state “Status”, an identifier FID of a feature, an identifier SID of a sensor, and partial histogram data 112 and an identifier HID thereof, as attributes for the designated RID 6001.

The feature management function 113 additionally has the function of using the interval management function 115 to input as a query the FIDs 3011 and 3021 of the target feature aggregate and the start time and end time representing the interval to be searched, and the state label, and searching all intervals that are included within the feature aggregate and the intervals to be searched and that match the state label.

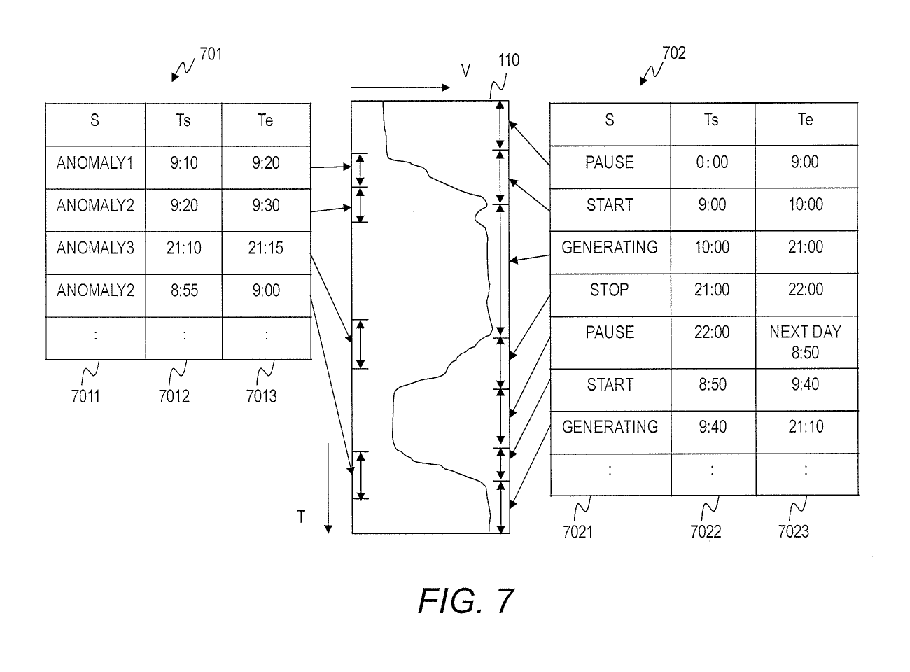

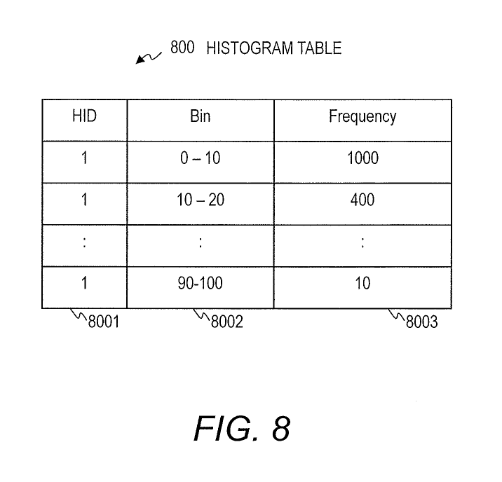

FIG. 7 shows the relationship between the interval data 111 and the time series data 110. The relationship between the interval data 111 and the time series data 110 will be described with reference to FIG. 7. In FIG. 7, tables 701 and 702 both show an example of interval data 111, and by contrast to the table 600 shown in FIG. 6, include only the start times Ts (7012, 7022), the end times Te (7013, 7023), and the states S (7011, 7021) for simplification.

The time series data 110 in FIG. 7 shows time series data of a sensor of a power generating device as an example. The table 701 records as the state S (7011) anomalies 1, 2, and 3, and the table 702 records as the state S (7021) pause, start, power generation, and stop. The tables 701 and 702 may be a plurality of tables or a single table. As shown with the startup state (9:00-10:00) on the second row of table 702 and the anomaly 1 (9:10-9:20) in table 701, there may be an overlap in ranges indicated by the intervals in the interval data 111.

If the analysis terminal 101 refers to the time series data 110, then it uses the feature management function 113. The feature management function 113 refers to XML 300 and tables 301 and 302, which are an implementation of feature data 108 and feature aggregate data 107, to acquire the FID (3011, 3021) of feature data corresponding to the requested attribute or the related path.

The feature management function 113 acquires the SID 4003 corresponding to the acquired FID with reference to the table 400, which is an example of the sensor data 109. The feature management function 113 refers to the table 600, which is one implementation of the interval data 111, and acquires the aggregate of interval data of the identifier FID of the corresponding feature data, the identifier SID of the corresponding sensor, and the corresponding state “Status”.

Additionally, the feature management function 113 acquires the corresponding time series data according to the corresponding SID and the start time and end time of the aggregate of interval data from any one of the tables 500, 501, and 502, which are an example of the time series data 110.

As a result, the feature data (FID), sensor (SID), partial histogram data 112 (HID), and states associated with the interval of the start time and end time are set for the interval data 111. With reference to the interval data 111, it is possible to acquire the time series data 110 and partial histogram data 112 (HID) of the sensor associated with the interval.

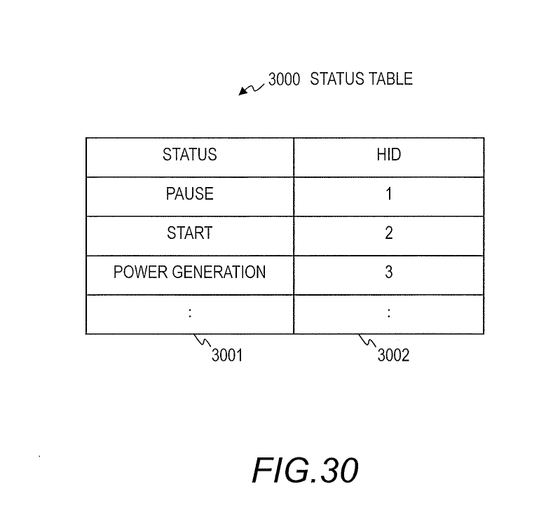

An example of a management structure of the state data 125 is shown in table 3000 of FIG. 30. The table 3000 includes a state 3001 that is a state label uniquely identifying a state, and an identifier HID of the partial histogram data 112 in the state.

FIG. 8 shows the structure of the partial histogram data 112. The partial histogram data 112 and the histogram management function 116 will be described with reference to FIG. 8.

The histogram is data in which the frequency of occurrence of measurement values determined in advance are managed as a table or a graph.

An example of a management structure of the partial histogram data 112 is shown in table 800 of FIG. 8. The partial histogram data 112 is comprised of an HID 8001 that is an identifier uniquely identifying the partial histogram data, a Bin 8002 that indicates a range, and a frequency 8003 that indicates the frequency of occurrence of a measurement value in the range.

The first row of the table 800 is a histogram with an HID of 1 and indicates that there are 1000 instances of measurement values of greater than or equal to 0 and less than 10, and the second row is also the histogram with an HID of 1 and indicates that there are 400 instances of measurement values of greater than or equal to 10 and less than 20.

If the range is calculable in some manner such as being a fixed length, the bin 8002 may be omitted from the histogram data 112 with a calculation formula being stored as the setting parameter 124 shown in FIG. 2.

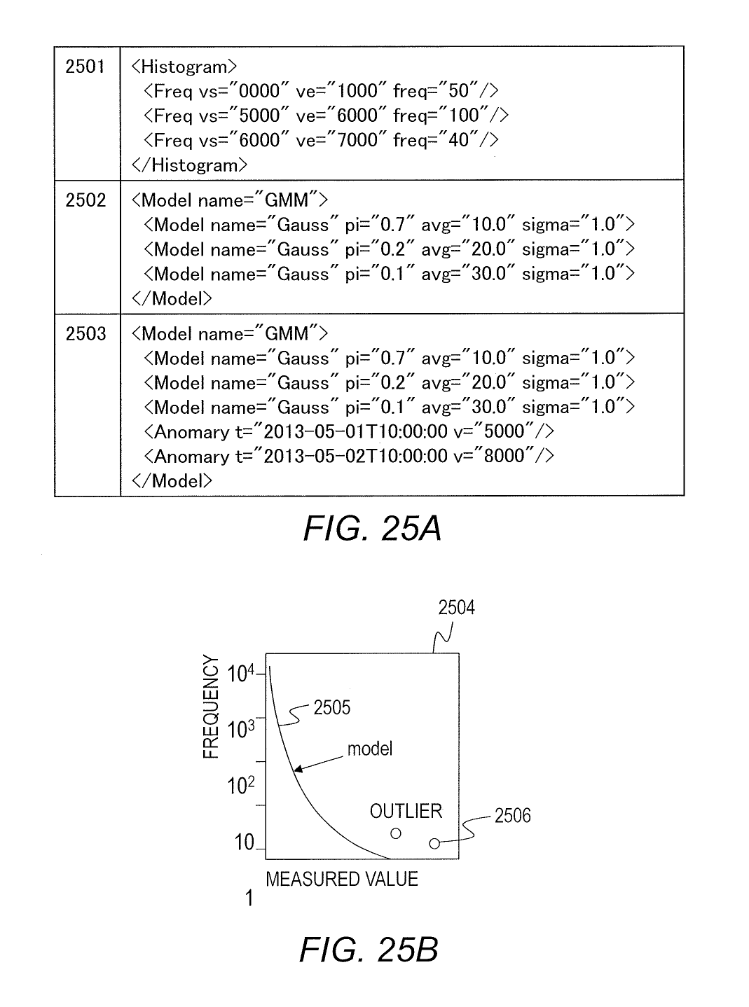

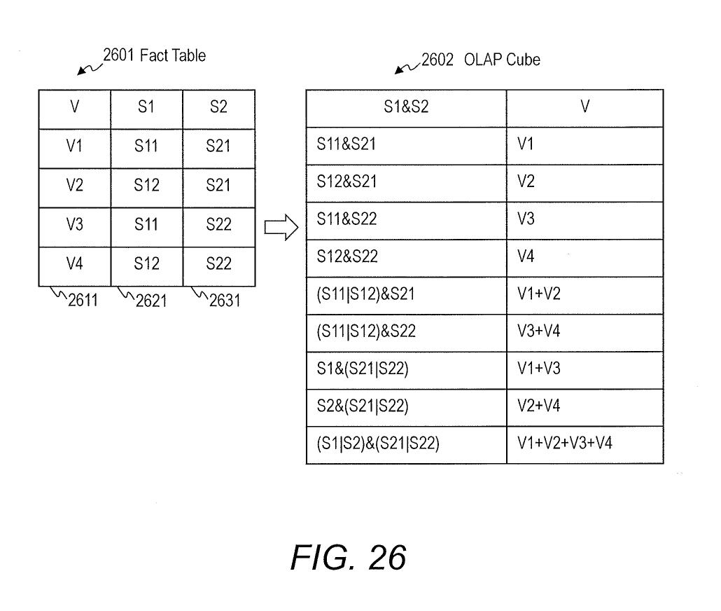

FIGS. 25A and 25B show the structure of the partial histogram data. FIG. 25A shows XML expressions of the partial histogram data. FIG. 25B is a graph showing the relationship between the measurement value and frequency in the partial histogram data.

Another management structure for the partial histogram data 112 will be described with reference to FIGS. 25A and 25B. XML 2501 is almost identical to the content of the table 800 shown in FIG. 8, and manages the frequency freq in a measurement value range of vs to ve.

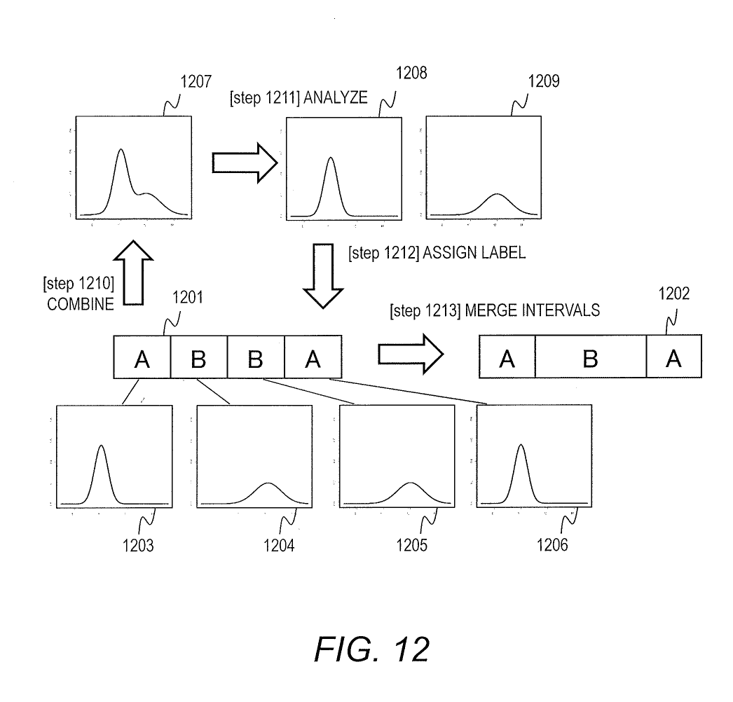

Here, the size of the histogram can be reduced by omitting intervals where the frequency is 0 (such as vs=1000 to ve=5000). XML 2502 expresses a histogram as a model such as GMM to be described later in the description of FIG. 12. In XML 2502, the histogram is expressed such that the three Gauss distributions where the average is 10 and the variance is 1, the average is 20 and the variance is 1, and the average is 30 and the variance is 1 are combined at a proportion of 0.7, 0.2, and 0.1, respectively.

By applying the method of XML 2502, it is possible to greatly reduce the size of the histogram. The XML 2503 has a structure that includes, in addition to the information of XML 2502, anomaly tags where measurement values at frequencies less than or equal to the threshold are added as outliers. If the histogram is expressed in the form of XML 2502, then this results in a margin of error.

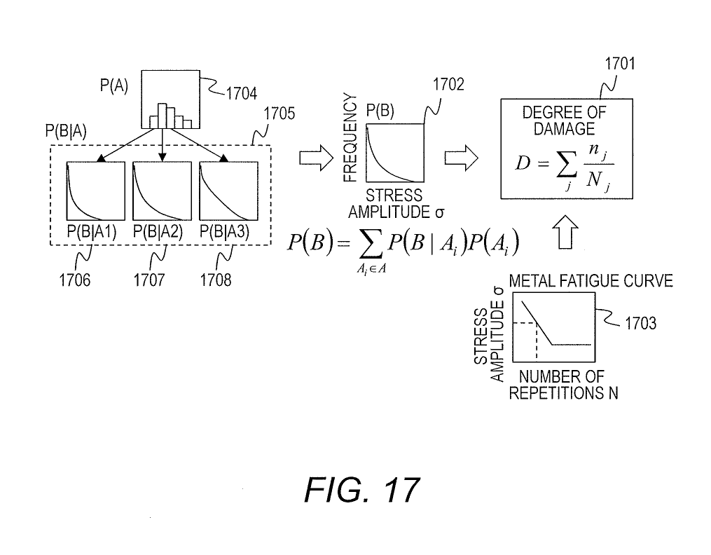

If applied to the histogram of stress oscillation in a vehicle, as described later in the metal fatigue curve 1703 shown in FIG. 17, there is no major impact on the amount of damage if the stress amplitude is small, but if the stress amplitude is large, then even if the frequency is small, this can result in a large amount of damage.

Thus, if the histogram of the stress amplitude is expressed in the format of XML 2502 of FIG. 25A, then as shown in FIG. 25B, there are cases in which the outlier 2506 in the model 2505 cannot simply be ignored as an error. However, by managing together both the model 2505 and the outlier 2506 as in XML 2503 of FIG. 25A, it is possible to manage a histogram that can be used for damage evaluation.

The partial histogram data 112 can manage as an attribute of the interval data 111 the histogram attribute shown in table 600, for example. The partial histogram data 112 can manage as an attribute of the feature data 108 or the feature aggregate data 107 the histogram attribute shown in table 301, for example.

The data management function 105 and the histogram management function 116 have a function of recording histogram management function 112 as an attribute of the interval data 111, the feature data 108, and the feature aggregate data 107, and the function of searching the partial histogram data 112 as an attribute of the interval data 111, the feature data 108, and the feature aggregate data 107.

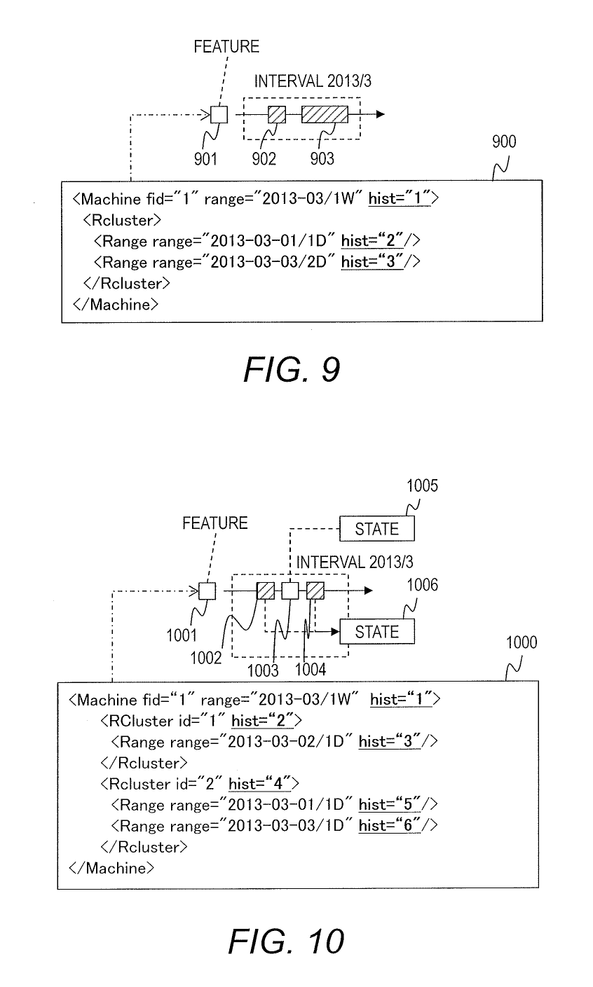

FIG. 9 shows the relationship between feature data 108, and the interval data 111 and partial histogram data 112. The relationship between the partial histogram data 112 and the interval data 111 and the relationship between the partial histogram data 112 and the feature data will be described with reference to FIG. 9. XML 900 is an XML script showing an example of the feature data 108. For ease of explanation, in XML 900, “range” and “hist” are coded as attributes of the Machine tag, but by reinterpreting these as sub elements of the Machine tag, the same structure as XML 300 shown in FIG. 3A is attained. Thus, XML 900 can accumulate data in the format of the tables 301 and 302 shown in FIGS. 3B and 3C.

For ease of explanation, in FIG. 9, the “range” is indicated as “2013-03/1W” and this indicates “1 week starting in March 2013” according to ISO 8601. Similarly, “2013-03-01/1D” signifies “1 day from Mar. 1, 2013”. Thus, “range” can be stored as the two attributes of start time and end time in the interval data 111 of FIG. 6.

In XML 900, the feature 901 has an interval of 1 week from March 2013, and includes the interval data 902 of 1 day from Mar. 1, 2013, and the interval data 903 of 2 days from March 3. The histogram management function 116 manages the partial histogram data 112 designated as hist=1 in XML 900 for the feature 901, and for the intervals 902 and 903, manages the partial histogram data designated as hist=2 and hist=3, respectively. In this manner, it is possible to manage a plurality of pieces of interval data for the feature 901.

FIG. 12 shows an example of a process performed in the similar interval combining function 1913. The process of the similar interval combining function 1913 within the partial interval histogram generation function 119 will be described with reference to the example of FIG. 12. First, by the unit interval histogram generation function 1916, the time series data 110 is separated into unit intervals such as indicated in the interval aggregate 1201 in the drawing. In the example in the drawing, the interval aggregate 1201 is divided into four intervals.

In this example, the separated intervals respectively store the partial histogram data 1203, 1204, 1205, and 1206. The similar interval combining function 1913 is performed in the following four steps.

The similar interval combining function 1913 combines the partial histogram data 1203, 1204, 1205, 1206 and acquires the histogram 1207 (step 1210).

The similar interval combining function 1913 divides the histogram 1207 into a plurality of histograms 1208 and 1209 (step 1211). An example of a method to divide the histogram is the Gaussian mixture model (GMM) by which a histogram having a plurality of peaks is divided into a plurality of Gauss distributions each having a single peak.

The similar interval combining function 1913 compares the similarity between the partial histogram data 1203, 1204, 1205, 1206 and the divided plurality of histograms 1208 and 1209 to assign labels (step 1212). The partial histogram data 1203 and 1206 are similar to the histogram 1208 and are therefore assigned a label A, and the partial histogram data 1204 and 1205 are similar to the histogram 1209 and are therefore assigned a label B. The similar interval combining function 1913 determines, if the similarity in frequency in the two histograms is greater than or equal to a prescribed threshold, that the histograms are similar, and assigns the same label therefor. The similar interval combining function 1913 determines, if the similarity in frequency in the two histograms is less than the prescribed threshold, that the histograms are dissimilar, and assigns different labels therefor. The labels may be state labels of the interval information.

The similar interval combining function 1913 generates a new interval by combining adjacent intervals with the same label, and generates a histogram for the new interval (step 1213). The histogram for the new interval can be assigned as secondary information to the interval information. Alternatively, a histogram generated as secondary information to the state label may be stored.

By the processes above, the intervals (1204, 1205), which are adjacent labels assigned the label B in the interval aggregate 1201, are joined together to create an interval aggregate 1202 including three labels.

Alternatively, the same aggregate label may be assigned as secondary information to the time series data 110 classified as the same according to the similarity of the histograms, with histograms of the time series data 110 assigned the same aggregate label being generated, and with the aggregate label and histogram being stored together and managed.

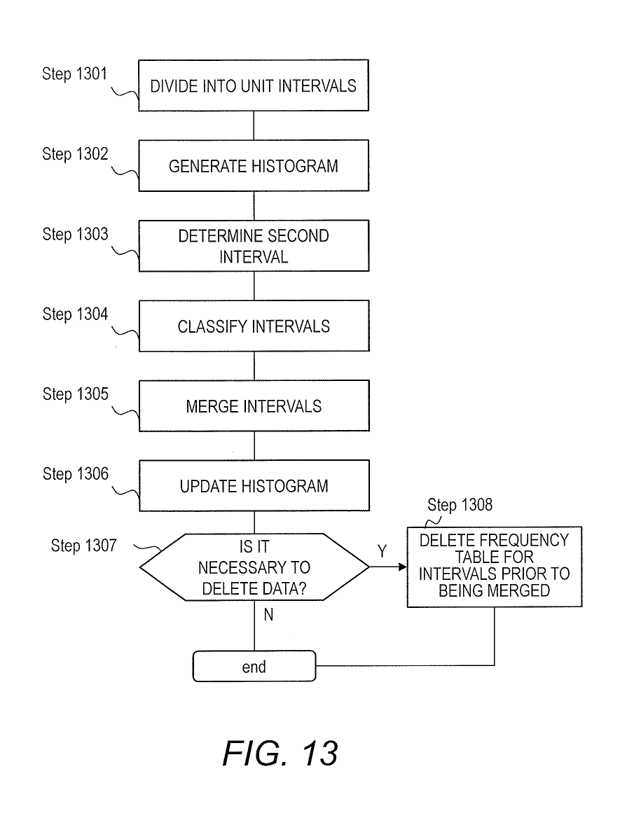

FIG. 13 is a flowchart showing an example of the process performed in the partial interval histogram generation function. The processes of the chronology recording function 1918, the unit interval histogram generation function 1916, and the similar interval combining function 1913 will be described with reference to the flowchart of FIG. 13.

First, the unit interval histogram generation function 1916 divides the time series data 110 received by the chronology recording function 1918 into prescribed unit intervals (step 1301). A given unit interval is defined in advance as a parameter by adjusting the analysis granularity based on the purpose and the amount of data, and is stored as the setting parameter 124.

The unit interval is set as the minimum granularity of the analysis results. If start, turn, and stop state characteristics of a vehicle are analyzed, for example, then start, turn, and stop are performed for at least approximately 10 seconds, and thus, it is preferable that the unit interval be set to 10 seconds. Similarly, if lifestyle pattern characteristics such as sleep time and eating time are to be analyzed according to the household power consumption, then it is preferable that the unit interval be set to 15 minutes because sleep time and eating time are at least approximately 15 minutes long. From the perspective of data amount, it is preferable that the amount of data in the histogram be less than or equal to the amount of data in the original time series data. If the measurement frequency of the vibration stress sensor of the vehicle is 1 kHz, for example, then if the number of histogram bins is 1000 and the unit interval is set to 10 seconds, then the number of pieces of time series data is 1 kHz×10 seconds=10,000, whereas the amount of histogram data is 1000, which is 1/10 the Size of the Time Series Data.

The unit interval histogram generation function 1916 generates a histogram from the measurement values of the time series data 110 for all divided unit intervals (step 1302).

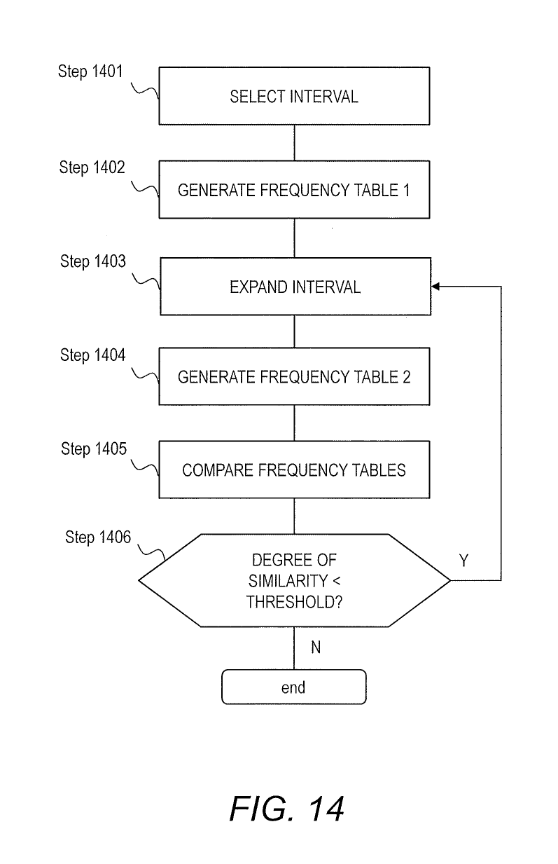

The unit interval histogram generation function 1916 creates a histogram from the measurement values of a second unit interval including the above-mentioned unit intervals (step 1303). The second unit interval needs to be a sufficiently long period to allow for statistical characteristics for analysis to appear in the histogram. If characteristics of a vehicle are to be analyzed, for example, then the second period would be the average time from engine start to engine stop (average time for a trip), which is 2 hours, for example, and if analyzing the characteristics of household power consumption, then a period of 24 hours is set for the second unit interval. The second unit interval, similar to the unit intervals above, may be defined in advance as a parameter and stored as the setting parameter 124. Also, the second unit interval may be set automatically in a process to be described later with reference to FIG. 14.

The unit interval histogram generation function 1916 generates a mixed model from histograms in the second unit interval. The unit interval histogram generation function 1916 divides the combined histogram into a plurality of histograms according to Gaussian distribution or the like as described above. The unit interval histogram generation function 1916 classifies the unit interval by comparing the similarity between the separated models and the histograms at the unit intervals (step 1304).

The similarity of the histograms is calculated by using the Bhattacharyya coefficient shown in formula 1, for example.

$$( Formula 1 )$$

$$ρ ( p , q ) = {\sum }_{u = 1}^{m} \sqrt{{p}_{u} {q}_{u}} \qquad ( Formula 1 )$$

Here, p and q are normalized histograms to be compared, and m is the number of bins. The normalized histogram is attained by normalizing the histograms such that the total frequency of the respective bins therein is 1. The similarity is a value of 0 to 1 and a perfect match would take on a value of 1.

The classification of unit intervals is performed by comparing the similarity of the unit interval and all models, and the unit intervals are classified in the model with the highest degree of similarity. Here, the unit interval may be classified as any of the models, but if the unit interval is not similar to any of the models, then in some cases it is difficult to classify the unit interval as any one such model. In such a case, a configuration may be adopted in which a new classification item referred to as “outlier” is provided, where if the similarity of the most similar model is greater than or equal to a predefined threshold, then the unit interval is classified as “outlier”.

Next, the unit interval histogram generation function 1916 merges adjacent unit intervals with the same classification for each of the separated models and the histograms at the unit intervals (step 1305).

The unit interval histogram generation function 1916 generates a histogram for the combined interval, and records the combined interval and the histogram in the histogram management table 1911 (that is, the interval data 111) (step 1306).

If there is a need to delete data, then the unit interval histogram generation function 1916 deletes from the histogram management table 1911 the interval data and the histogram prior to merging of the intervals in the merged interval (step 1307). The need to delete data takes one of two values: true or false, is defined in advance as a parameter, and is stored as the setting parameter 124, for example. If there is no need to delete data (N), then the process ends.

An example of effects of deleting data in the present embodiment will be described. If a time series data 110 with a measurement interval of 100 Hz is present, then this signifies 3.1×10̂9 pieces of data over one year. When generating a histogram with 1000 bins per minute, the number of histograms would be 5.3×10̂5 and the number of pieces of data would be 5.3×10̂8. If a histogram is to be generated hierarchically, the length of the intervals would be doubled while the number of histograms would be cut by half, which means that the number of histograms would be 1.1×10̂6.

If 5% of the entire interval is comprised of singularities, then the number of histograms in the singular intervals is 2.7×10̂4, and if adjacent singular intervals could all be merged, then the number of histograms per minute would be 5.3×10̂4, which is 10% of the amount of data prior to merging. If the histograms are generated hierarchically and the non-singular intervals are merged at each hierarchy level, then the number of histograms per hierarchy level is estimated to be the small value of 5.3×10̂4. According to this calculation, the number of histograms in the hierarchy would be 2.8×10̂5, which would be approximately 25% of the amount of data prior to merging.

FIG. 14 is a flow chart showing an example of a process of calculating the second unit interval in the similar interval combining function 1913 performed in step 1303 in FIG. 13.

The similar interval combining function 1913 first selects a first unit interval (step 1401).

The similar interval combining function 1913 generates a first histogram (frequency table) for the first unit interval (step 1402).

The similar interval combining function 1913 next expands the first unit interval. An interval including the first unit interval with double the interval length is set as an expanded interval, for example (step 1403). The rate of expansion for the unit interval is set in advance.

The similar interval combining function 1913 generates a second histogram for the expanded interval (step 1404).

The similar interval combining function 1913 compares the similarity between the first histogram and the second histogram (step 1405). The calculation for similarity is similar to what was described above.

If it is determined that the similarity is below a threshold and the histograms are determined therefore to be dissimilar, then the similar interval combining function 1913 replaces the first histogram with the second histogram and returns to step 1403. Otherwise, the expanded interval is set as the second unit interval and the process is ended.

By the process above, while the similarity is less than the threshold, the second interval is expanded. Intervals classified as being dissimilar (not the same) according to the similarity of the histograms can be divided and replaced with new histograms.

The dissimilar interval separation function 1915 of FIG. 19 separates the interval recorded by the interval recording function 1917 into a plurality of intervals according to the characteristics thereof and records the plurality of intervals. The dissimilar interval separation function 1915 can be realized by using the unit interval histogram generation function 1916 and the similar interval combining function 1913. In other words, the dissimilar interval separation function can be realized by separating the intervals recorded by the interval recording function 1917 into unit intervals according to the flowchart of FIG. 13 and by merging intervals.

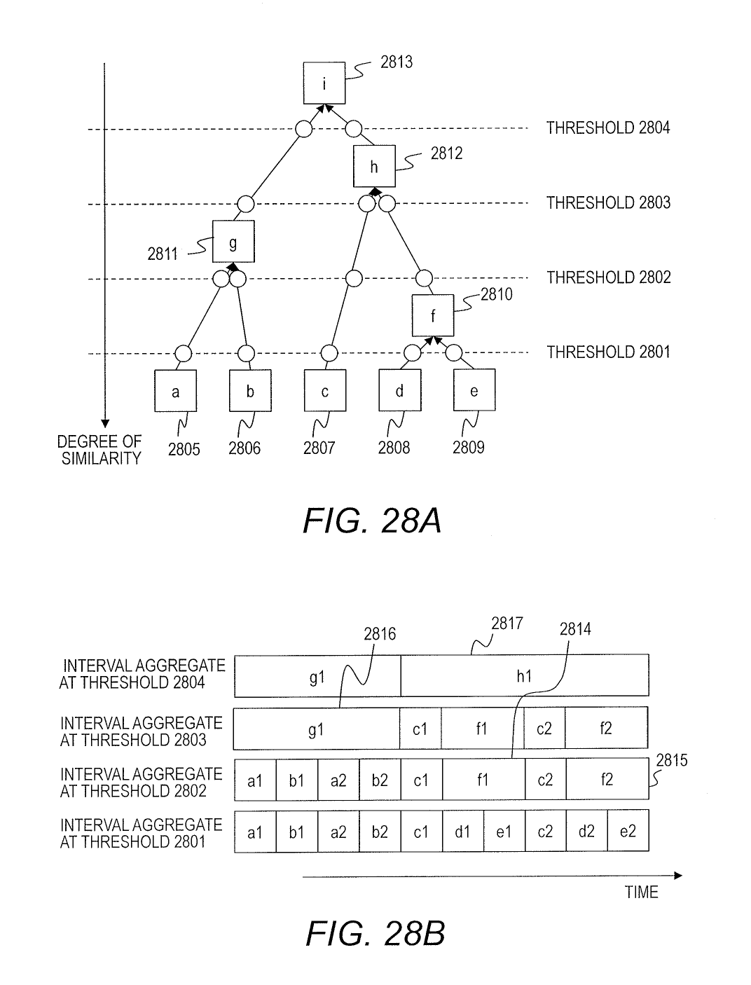

FIGS. 28A and 28B show a process of a second implementation performed in the similar interval combining function 1913. The process performed in the second implementation of the similar interval combining function 1913 within the partial interval histogram generation function 119 will be described with reference to the example of FIGS. 28A and 28B.

In the second implementation, the similar interval combining function 1913 employs agglomerative hierarchical clustering. The similar interval combining function 1913 divides the relevant interval into unit intervals and determines that interval states a (2805), b (2806), c (2807), d (2808), and e (2809) were attained.

The similar interval combining function 1913 generates a histogram for each interval state, and from the combination of all interval states acquires a pair of states having the highest degree of similarity, that is, the most similar pair. The similar interval combining function 1913 uses formula 1 to evaluate similarity, for example. In the example of FIG. 28A, the state d and the state e (2809) are the most similar. Histograms of the state d (2808) and the state e (2809) are generated and assigned a state f (2810).

Next, the similar interval combining function 1913 removes the state d (2808) and the state e (2809), and searches, from all combinations within the aggregate with the state f (2810) added in, the pair with the highest degree of similarity, and attains a state g (2811) from the states a and b. Repeating this process, the similar interval combining function 1913 obtains a state h (2812) from the state c (2807) and state f (2810), and a state i (2813) from the state g (2811) and state h (2812).

By the operations above, a tree structure known as a dendrogram is attained in which the states are coupled in order of similarity. The vertical axis of the dendrogram is the degree of similarity. The dendrogram can classify states by a plurality of similarity thresholds 2801 to 2804. If the threshold 2801 is applied, for example, then the five states a, b, c, d, and e are attained, and if the threshold 2802 is applied, then the four states a, b, c, and f are attained. If the threshold 2803 is applied, then the three states g, c, and f are attained, and if the threshold 2804 is applied, then the two states g and h are attained.

Next, similar to step 1305, the similar interval combining function 1913 merges adjacent unit intervals belonging to the same state. As shown in FIG. 28B, if the unit intervals a1, b1, a2, b2, c1, d1, e1, c2, d2, and e2 of the relevant interval respectively belong to the states a, b, a, b, c, d, e, c, d, and e, then there are no adjacent intervals belonging to the same state, and thus, no interval merging occurs.

However, in the state classification at the threshold 2802, the intervals d1 and e1 belong to the same state f, and therefore can be merged to the interval f1 (2814). Also, the intervals d2 and e2 can similarly be merged to the interval f2 (2815). Similarly, at the threshold 2803, the unit intervals a1, b1, a2, and b2 can be merged to the interval g1 (2816), and at the threshold 2804, the intervals c1, d1, e1, c2, d2, and e2 can be merged to the interval h1 (2817). By using this method, it is possible to attain the merged intervals f1, f2, g1, and h1.

By managing the histogram of all the merged intervals, the similar interval combining function 1913 can efficiently attain a histogram of a state corresponding to a given similarity threshold.

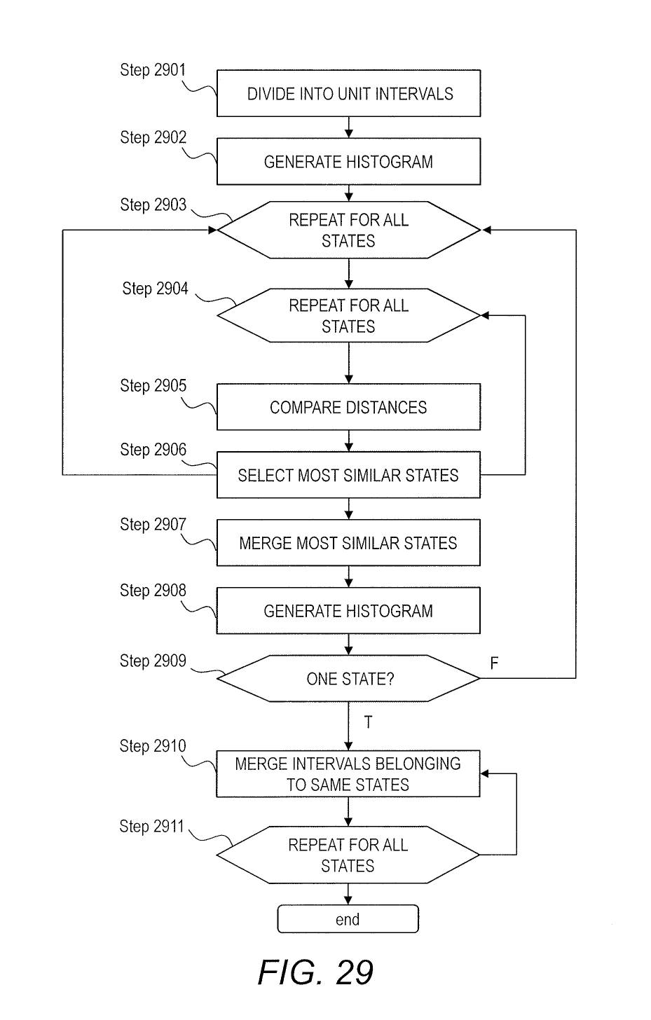

FIG. 29 is a flowchart of a process performed in a second implementation of the similar interval combining function 1913.

The similar interval combining function 1913 divides the time series data into prescribed unit intervals similar to step 1301 of FIG. 13 (step 2901).

The similar interval combining function 1913 generates a histogram of measurement values in unit intervals, similar to step 1302 of FIG. 13 (step 2902).

The similar interval combining function 1913 sets the state labels in the respective unit intervals to different states, respectively, and repeats steps 2904 to 2906 for all the set states (step 2903).

The similar interval combining function 1913 repeats steps 2905 to 2906 for all states excluding those selected in step 2903 (step 2904).

The similar interval combining function 1913 calculates a similarity using formula 1 or the like for the pair of states selected in steps 2903 and 2904 (step 2905).

The similar interval combining function 1913 selects the pair with the highest degree of similarity from among all combinations of states (step 2906).

The similar interval combining function 1913 merges the combination with the highest degree of similarity and creates a new state (step 2907).

The similar interval combining function 1913 generates a new histogram for the new state (step 2908).

The similar interval combining function 1913 repeats steps 2903 to 2908 until all states are merged into one (step 2909).

The similar interval combining function 1913 creates a histogram by merging intervals belonging to the same state, similar to step 1305 of FIG. 13, and then records the histogram as partial histogram data 112 (step 2910).

The similar interval combining function 1913 applies the process of step 2910 repeatedly on all states created in step 2907 (step 2911).

By the process above, it is possible for the similar interval combining function 1913 to attain with ease a histogram of a state corresponding to a given similarity threshold.

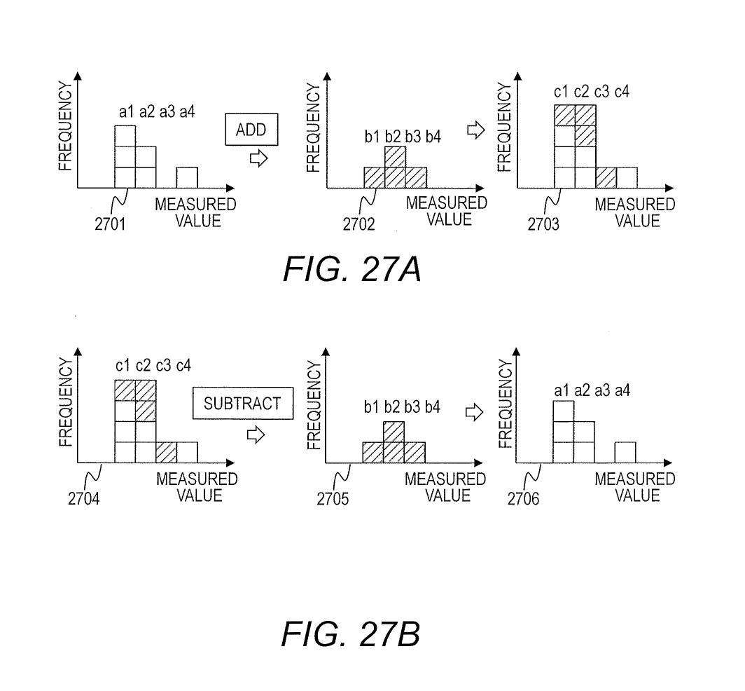

FIGS. 27A and 27B are for describing the process of the histogram addition/subtraction function 1914. The histogram addition/subtraction function 1914 is used in step 1303 of FIG. 13 and step 1404 of FIG. 14. The histograms have the property of being able to be created by addition or subtraction. That is, the histogram of a given interval is an aggregate of the respective measurement values in the interval, and thus, by adding the aggregate for the measurement values of histograms of a plurality of non-overlapping intervals, it is possible to generate a histogram for all of the plurality of intervals.

As shown in FIG. 27A, for example, when a histogram 2701 of a certain interval A and a histogram 2702 in an interval B that does not overlap interval A are provided, then a histogram 2703 of an interval C attained by merging intervals A and B is attained by adding the frequencies of the bins of the histograms.

In other words, a frequency c1 of the histogram 2703 is the sum of a frequency a1 of the histogram 2701 and a frequency b1 of the histogram 2702, and this similarly applies to c2, c3, and c4. The combining of histograms covering a plurality of intervals is performed by formula 2 below.

$$( Formula 2 )$$

$${r}_{u} = {\sum }_{k} {p}_{k , u} \qquad ( Formula 2 )$$

Here, r is a combined histogram, ru is the frequency of a bin number u of the combined histogram, pk is the histograms of the respective intervals from which the combined histogram was created, and pk,u is the frequency of the bin number u in the histograms of the respective intervals.

Similarly, when a histogram 2704 of an interval C and a histogram 2705 of an interval B encompassed in the interval C are provided, then by subtracting the frequencies in the bins of the interval B from the frequencies in the bins of the interval C, it is possible to generate a histogram 2706 of an interval A defined as “an interval formed by subtracting the interval B from the interval C”.

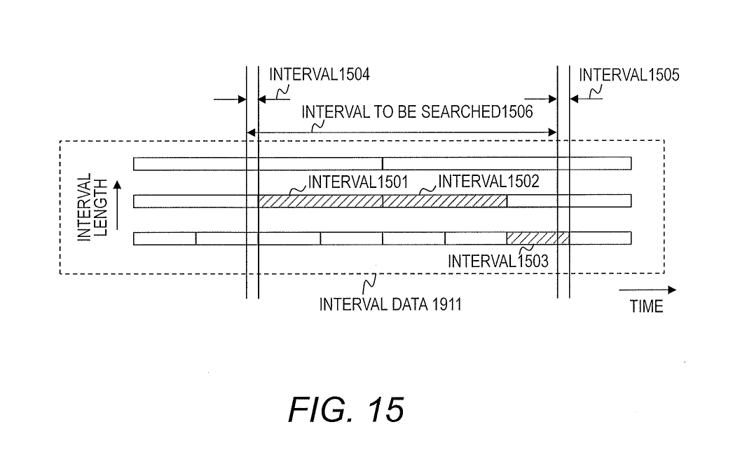

FIG. 15 shows an example of the process performed in the per-interval histogram combination function 1908. An example of the process performed in the per-interval histogram combination function 1908, which is a component of the interval histogram generation function 120, will be described with reference to FIG. 15.

The per-interval histogram combination function 1908 generates histograms of the interval to be searched by a combination of the partial histogram data 112. In FIG. 15, it is assumed that a plurality of pieces of interval data 111 of differing interval lengths including intervals 1501, 1502, and 1503, and the corresponding partial histogram data 112 are stored in the time series data store 106.

It is assumed here that a request to generate a histogram in the interval 1506 to be searched has been received from the analysis terminal 101 through the interface 1901. The per-interval histogram combination function 1908 covers the intervals to be searched and selects a combination of the lowest number of partial interval histograms. The per-interval histogram combination function 1908 uses the histogram addition/subtraction function 1914 to generate a target histogram by adding or subtracting the selected partial interval histogram.

In the example of FIG. 15, the intervals 1501, 1502, and 1503 form the combination of the lowest number of partial interval histograms. On the other hand, when comparing the interval 1506 to be searched with the merged intervals 1501, 1502, and 1503, the merged intervals have an extra interval 1505 and lack the interval 1504.

If no partial interval histogram data exists for the corresponding intervals 1504 and 1505, the per-interval histogram combination function 1908 uses the chronology histogram generation function 1910 to generate a histogram corresponding to the intervals 1504 and 1505 from the time series data 110, adds the histogram of the interval 1504 to the merged intervals, and subtracts the histogram of the interval 1505, thereby attaining a histogram of the interval 1506 to be searched.

Compared to the histogram addition/subtraction function 1914, there is a greater processing cost for histogram generation using the chronology histogram generation function 1910. On the other hand, the histogram has the characteristic that the shape thereof is not changing greatly as a result of minute interval differences. Thus, when requesting histogram generation from the analysis terminal 101, by further applying a request accuracy threshold of the histogram, the selection of a combination of the interval 1506 to be searched and the partial interval histogram can be stopped when the time difference from the interval covered by this combination becomes less than the request accuracy threshold. By employing this method, the probability of using the chronology histogram generation function 1910 is reduced, thereby reducing the histogram generation cost.

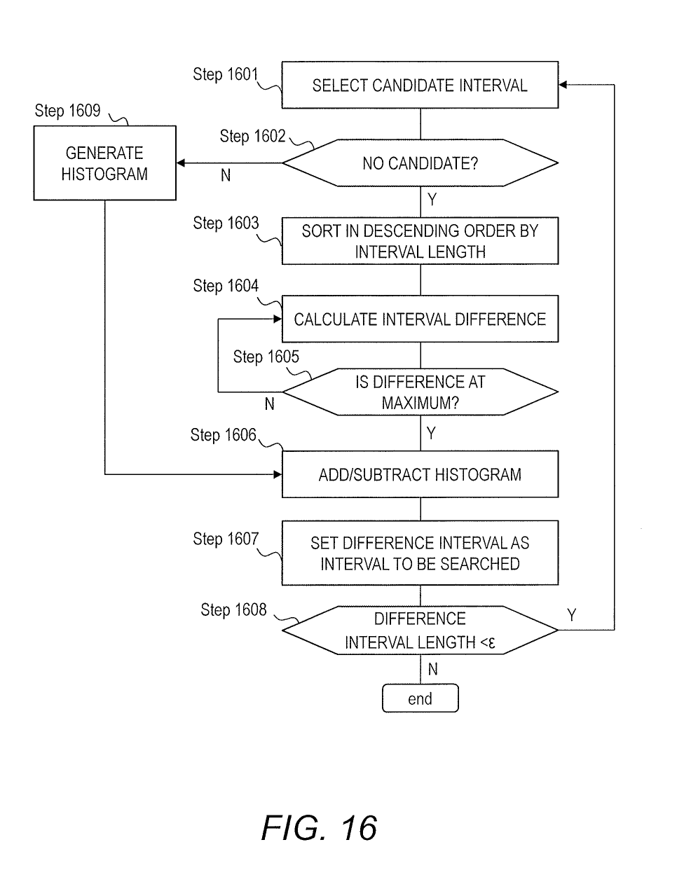

FIG. 16 shows a flowchart of an example of the process performed in the per-interval histogram combination function 1908. The per-interval histogram combination function 1908 selects all partial interval histograms including the interval to be searched as candidate intervals (step 1601).

If no candidate interval is present, then the per-interval histogram combination function 1908 progresses to step 1609 and selects the time series data 110 corresponding to the candidate interval from the time series data store 106 and generates a histogram (step 1602). After the histogram is generated, the process progresses to step 1606.

If a candidate is present, then the per-interval histogram combination function 1908 sorts the partial interval histograms in all candidate intervals in descending order by interval length (step 1603).

The per-interval histogram combination function 1908 starts scanning from the interval with the greatest length and calculates the difference between the interval being searched and the candidate interval (step 1604).

The per-interval histogram combination function 1908 selects the interval with the greatest length (step 1605). If the difference is not at a maximum, then the process returns to step 1604 and the process repeats.

The per-interval histogram combination function 1908 adds or subtracts the histogram according to the relationship between the interval being searched and the candidate intervals (step 1606).

The per-interval histogram combination function 1908 sets the difference interval as the interval to be searched (step 1607).

The per-interval histogram combination function 1908 repeatedly executes steps 1601 to 1607 until the length of the difference interval is less than a prescribed threshold ε (step 1608). Here, the prescribed threshold ε is inputted from outside as an argument of the interface 1901. If, for example, a histogram with an interval length of 24 hours is requested with an allowable error in interval length of 1%, the interval length to be a threshold would be approximately 14 minutes. If a histogram with a precise interval 1506 to be searched is necessary, then the threshold is set to 0. On the other hand, since the histogram would evaluate broader characteristics of the time series data, a histogram with a precise interval would not necessarily be requested.

By performing threshold determination, the probability would be reduced for the execution of a function to combine partial interval histograms of intervals with short lengths such as the interval 1503 of FIG. 15, or a function to generate a histogram from time series data such as those of the intervals 1504 and 1505, and thus, it is possible to reduce the processing cost of histogram combination.

FIG. 17 shows an example of a process of the lifespan estimation function 121. The lifespan estimation function 121 will be described with reference to FIG. 17. Generally, metal fatigue life is calculated using the metal fatigue curve 1703 and a histogram 1702 having a stress amplitude of σ. The metal fatigue curve 1703 plots the maximum number of repetitions N that would result in fatigue failure for when a stress of a given amplitude σ is repeatedly applied to the metal, and is attained by performing a fatigue test in which stress of amplitude σ is applied repeatedly on a test piece and the number of repetitions until fatigue failure is counted.

A degree of damage D (1701) attained by the following formula 3 is used for fatigue life evaluation, and it is thought that fatigue failure would occur when the degree of damage D≧1.

$$( Formula 3 )$$

$$D = {\sum }_{j} \frac{{n}_{j}}{{N}_{j}} \qquad ( Formula 3 )$$

Here, j represents the bin number for each stress amplitude, Nj is the maximum number of repetitions of a given stress amplitude σj on the metal fatigue curve 1703, and nj is the current number of repetitions of the given stress amplitude σj.

In devices that are constantly in operation such as nuclear power plants, the current number of repetitions nj can be estimated by measuring the stress oscillation chronology in a given interval, creating a histogram of stress amplitudes using the rainflow counting method, and multiplying this histogram by the ratio of the current operation time and the measurement interval length.

On the other hand, in apparatuses such as dump trucks that have various driving states such as traveling while carrying a load, traveling while not carrying a load, sudden start, sudden stop, and sudden turns, it is necessary to combine histograms of stress amplitudes of the respective driving states in order to calculate the current number of repetitions nj.

The various driving states such as traveling while carrying a load, traveling while not carrying a load, sudden start, sudden stop, and sudden turns are designated as Ai, and the aggregate of driving states is designated as A. The probability of the respective states Ai occurring is P(Ai), and the probability distribution of all states is P(A).

Measurement values such as stress amplitude are designated as B. The conditional probability density distribution of the measurement values B in the respective states Ai is P(B|Ai). The probability density distribution P(B) of measurement values that do not depend on driving state are attained by the following formula 4 by the Bayes' theorem.

$$( Formula 4 )$$

$$P ( B ) = {\sum }_{{A}_{i} ∈ A} P ( B \vert {A}_{i} ) P ( {A}_{i} ) \qquad ( Formula 4 )$$

In other words, if the probability distribution P(A) of all drive states and the probability density distribution P(B|Ai) of measurement values B in the respective driving states Ai are obtained, then the probability density distribution P(B) of the measurement values B that do not depend on the driving state is obtained. It is possible to estimate the current number of repetitions nj by multiplying the probability density distribution P(B) by the sum of stress amplitude occurrence frequencies per unit time, and further multiplying the resulting value by the ratio of current operation time and measurement interval length.

In performing the calculation of formula 4, P(B|Ai) is obtained by acquiring the histogram at the state Ai and normalizing the histogram such that the sum in the range direction is 1. The histogram in the state Ai is obtained by the per-state histogram combination function 1907 of FIG. 19.

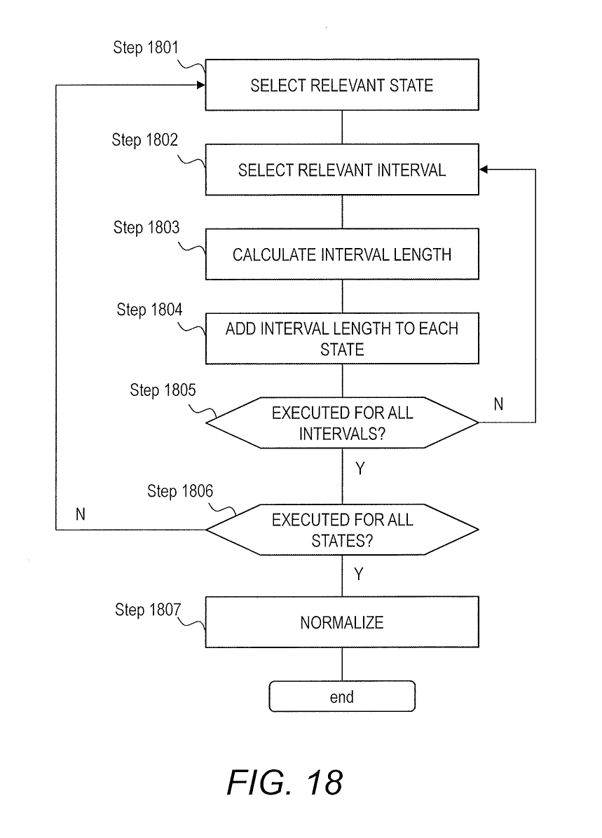

FIG. 18 is a flowchart for calculating the probability distribution P(A) of states. The flowchart for calculating the probability distribution P(A) of formula 4, that is, the probability of occurrence of each state Ai will be described with reference to FIG. 18.

The lifespan estimation function 121 selects all states from the intervals being searched and selects one of the states (step 1801).

The lifespan estimation function 121 selects all interval data from the selected state from the intervals being searched and selects one of the intervals (step 1802).

The lifespan estimation function 121 calculates the interval length from the start time and end time of the selected interval (step 1803).

The lifespan estimation function 121 aggregates the calculated interval length for each state (step 1804).

The lifespan estimation function 121 repeatedly executes steps 1802 to 1804 for all intervals of a given state (step 1805). When the process above is completed for all intervals of the given state, then the process progresses to step 1806.

The lifespan estimation function 121 repeatedly executes the process of steps 1801 to 1805 for all states (step 1806). When the process above is completed for all states, then the process progresses to step 1807.

The lifespan estimation function 121 normalizes the aggregate value of the respective states such that the sum of the aggregate of interval lengths for all states is 1, and sets this value as the probability distribution P(A).

In this manner, it is possible to measure the lifespan of apparatuses such as dump trucks that have various driving states such as traveling while carrying a load, traveling while not carrying a load, sudden start, sudden stop, and sudden turns.

By using the lifespan estimation function 121, it is possible to measure the lifespan of devices that operate in different regions. In one example, the probability distributions P(A) of the respective driving states are attained from travel log data of dump trucks used in mines in a region X and a region Y, and a stress histogram P(B|Ai) for each driving state is attained from stress sensor data of the dump truck in region X. Even if the dump truck in region Y is not provided with a stress sensor and a stress histogram cannot be attained for region Y, by combining the probability distribution P(A) of driving states in region Y with the stress histogram P(B|Ai) in the region X, it is possible to estimate the lifespan of the dump truck in region Y.

The singularity detection function 122 using the singularity detection interface 1903 shown in FIG. 19 will be described.

In a first implementation of the singularity detection function 122, the measurement value and state are inputted, and the singularity of the inputted measurement value is calculated. A state predetermined to be normal is inputted as the state, for example.

In FIG. 19, the singularity detection function 122 uses the per-state histogram combination function 1907 to generate a normal state histogram. The singularity detection function 122 further issues a response where the frequency of inputted measurement values in the generated histogram is a “non-singularity”. The lower the “non-singularity” is, the more singular the inputted measurement value is.

In a second implementation of the singularity detection function 122, the measurement interval and state are inputted, and the singularity of the inputted interval is calculated. A state predetermined to be normal is inputted as the state, for example. In FIG. 19, the singularity detection function 122 uses the per-state histogram combination function 1907 to generate a normal state histogram and a measurement interval histogram.

The singularity detection function 122 further calculates the similarity between the normal state histogram and the measurement interval histogram by formula 1, and issues as a response the degree of similarity as the “non-singularity”. The lower the “non-singularity” is, the more singular the inputted measurement value is.

As described above, in Embodiment 1, by combining the accumulated partial histograms in the time series data store 106 and adding or subtracting the histograms, it is possible to quickly generate a histogram pertaining to a desired interval or a desired feature.

### Embodiment 2

There are cases in which it is preferable, in the partial histograms for the time series data 110, that not only unit intervals or intervals formed by combining adjacent unit intervals of the same state, but also non-continuous intervals be managed as a “state”.

FIG. 10 shows Embodiment 2, and the relationship between state data and the partial histogram data. A management structure for associating the partial histogram data 112 with states will be described with reference to FIG. 10. XML 1000 is an XML script of an example of the feature data 108. The coding is similar to FIG. 9 of Embodiment 1.

In XML 1000, the feature 1001 has an interval of 1 week from March 2013, and in this interval are an interval 1002 of 1 day from Mar. 1, 2013, an interval 1003 of 1 day from Mar. 2, 2013, and an interval 1004 of 1 day from Mar. 3, 2013.

The intervals 1002 and 1004 are grouped with the state 1006, and the interval 1003 is grouped with the state 1005. Similar to FIG. 9, the histogram management function 116 manages the partial histogram data designated as hist=1 for the feature 1001, and for the intervals 1002, 1003, and 1004, manages the partial histogram data designated as hist=5, hist=3, and hist=6, respectively.

XML 1000 further manages partial histogram data designated as hist=2 and hist=4, respectively, for the states 1005 and 1006.

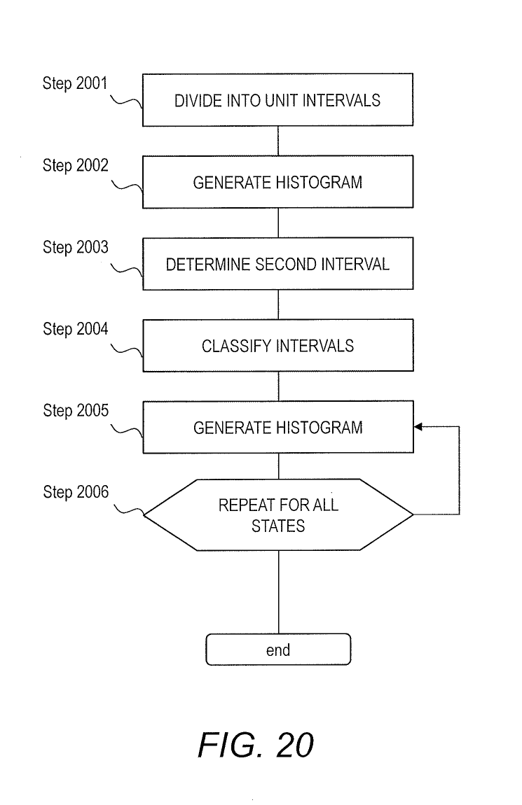

FIG. 20 is a flowchart showing Embodiment 2 of the present invention, and showing an example of the process performed in the partial interval histogram generation function 119.

A method of generating a partial histogram for each state by the partial interval histogram generation function 119 shown in FIG. 2 will be described with reference to FIG. 20. This is a modification of the similar interval combining function 1913 shown in FIG. 13, and partial histograms at the states 1005 and 1006 of XML 1000 are generated. Steps 2001 to 2004 are similar to steps 1301 to 1304 shown in FIG. 13 of Embodiment 1. In other words, the partial interval histogram generation function 119 divides the time series data 110 into prescribed unit intervals and generates a histogram from the measurement values of the time series data 110, and during the second unit interval including the unit intervals, a histogram of the measurement values is generated, and the similarity between the divided models and the histogram of the unit interval is compared (steps 2001 to 2004).

The partial interval histogram generation function 119 generates a histogram for all intervals classified as the same state and manages the histogram as information associated with the state (step 2005).

The partial interval histogram generation function 119 executes the process of step 2005 for all states.

By the process above, the histogram for all intervals classified in the state is managed as information associated with the state.

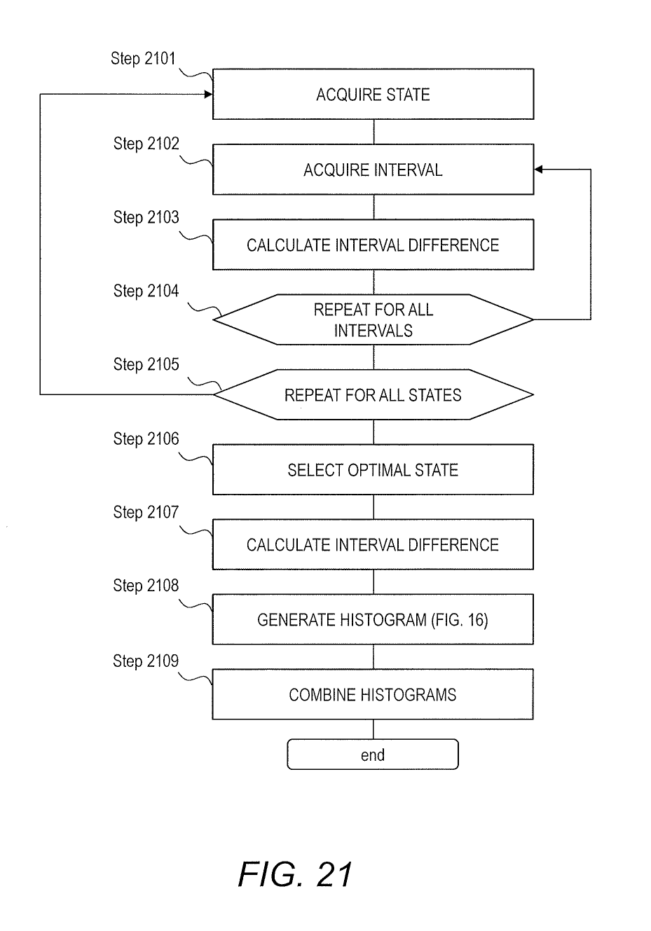

FIG. 21 is a flowchart showing an example of the process of generating a histogram using the partial histograms of the states. The process of generating a histogram using the partial histograms for the states by the interval histogram generation function 120 will be described with reference to FIG. 21.

The interval histogram generation function 120 selects all states from the intervals being searched and acquires one of the states (step 2101).

The interval histogram generation function 120 selects all intervals of the state in the intervals being searched and acquires one of the intervals (step 2102).

The interval histogram generation function 120 calculates the difference between the intervals being searched and the acquired interval and designates this as the interval difference between states (step 2103). The interval difference is an operation of removing overlapping portions between intervals. For example, the difference between the interval starting at 10:00 and ending at 11:00 and the interval starting at 10:10 and ending at 10:20 is two intervals including an interval starting at 10:00 and ending at 10:10 and an interval starting at 10:10 and ending at 11:00.

The interval histogram generation function 120 repeatedly applies the process of steps 2102 to 2103 to all intervals in the state (step 2104). When the process ends for all intervals, the process progresses to step 2105.

The interval histogram generation function 120 repeatedly applies the process of steps 2101 to 2104 to all the states (step 2105). When the process ends for all states, the process progresses to step 2106.

The interval histogram generation function 120 selects the optimal state that overlaps the most with the interval to be searched by selecting the interval difference with the shortest interval length for all states calculated in steps 2101 to 2105 (step 2106).

The interval histogram generation function 120 calculates the difference between the intervals being searched and the interval of the optimal state (step 2107).

The interval histogram generation function 120 executes the process shown in FIG. 16 in Embodiment 1 on the interval difference to generate a histogram (step 2108).

The interval histogram generation function 120 combines the histogram for the state selected in step 2106 with the histogram generated in step 2108.

By the process above, it is possible to generate a histogram in the interval being searched from the partial histograms of the states.

### Embodiment 3

There are cases in which the partial histograms for the time series data 110 are aggregated in the feature direction in addition to the time direction. In order to generate a histogram for power consumption distribution for 10 million households, for example, it would be necessary to combine 10 million histograms even when a histogram is present for each household.

On the other hand, if households are divided into 100 groups according to sameness, and if a partial histogram is generated in advance for each group, then when performing a search, only 100 histograms need to be combined.

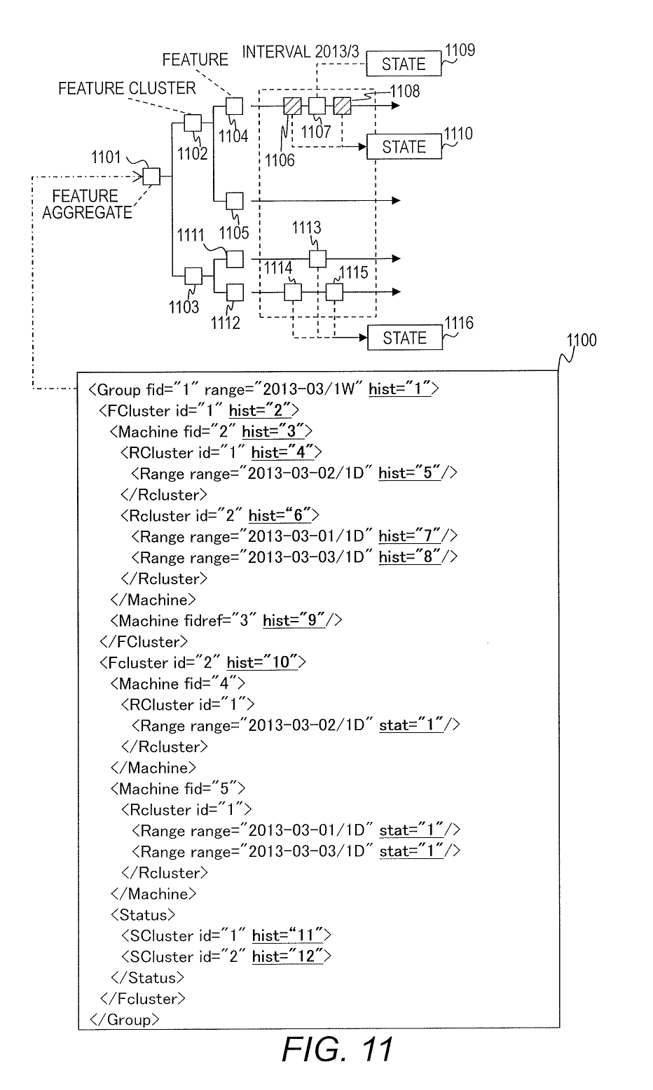

A management structure for associating the partial histogram data 112 with feature aggregate data 107, feature clusters, and intervals that overlap a plurality of features will be described with reference to FIG. 11. FIG. 11 shows the relationship between the feature aggregate data, and the state data and partial histogram data overlapping features.

XML 1100 is an XML script of an example of the feature aggregate data 107. The XML coding is similar to FIG. 9 of Embodiment 1.

In XML 1100, a feature aggregate 1101 has an interval of 1 week from March 2013, and includes therein features 1104, 1105, 1111, and 1112. The features 1104 and 1105 and the features 1111 and 1112 are respectively grouped, and managed as a feature cluster 1102 and a feature cluster 1103.

This example structure expresses that at a certain plant there are two devices made by manufacturer 1 and two devices made by manufacturer 2. Similar to FIG. 10 of Embodiment 1, the feature 1104 has intervals 1106, 1107, and 1108, which are grouped, respectively, into states 1109 and 1110.

Meanwhile, the features 1111 and 1112 constituting the feature cluster 1103 respectively have intervals 1113, 1114, and 1115, all of which are grouped in the same state 1116.

The partial histogram data 112 can be applied to the intervals and states. In the example of XML 1100, the partial histogram data 112 is set in the following 12 locations.

Similar to FIG. 10 of Embodiment 1, partial histogram data is managed in which hist=3 is designated for the feature 1104, hist=9 is designated for the feature 1105, hist=7 is designated for the interval 1106, hist=5 is designated for the interval 1107, hist=8 is designated for the interval 1108, hist=5 is designated for the state 1109, and hist=6 is designated for the state 1110. Additionally, partial histogram data is managed in which hist=2 is designated for the feature cluster 1102, hist=10 is designated for the feature cluster 1103, these feature clusters constituting a feature aggregate, and hist=1 is designated as the feature aggregate 1101 including the feature clusters 1102 and 1103. Also, partial histogram data is managed in which hist=11 is designated for the state 1116 for the intervals 1113, 1114, and 1115 at the plurality of features 1111 and 1112 in the feature cluster 1103.

As a result of the configuration above, the partial feature histogram generation function 117 expanded so as to associate the partial interval histogram generation function 119 with the feature aggregate, and the feature histogram generation function 1118 expanded so as to associate the interval histogram generation function 120 with the feature aggregate, it is possible to combine histograms corresponding to feature aggregates similar to combining histograms with intervals.

### Embodiment 4

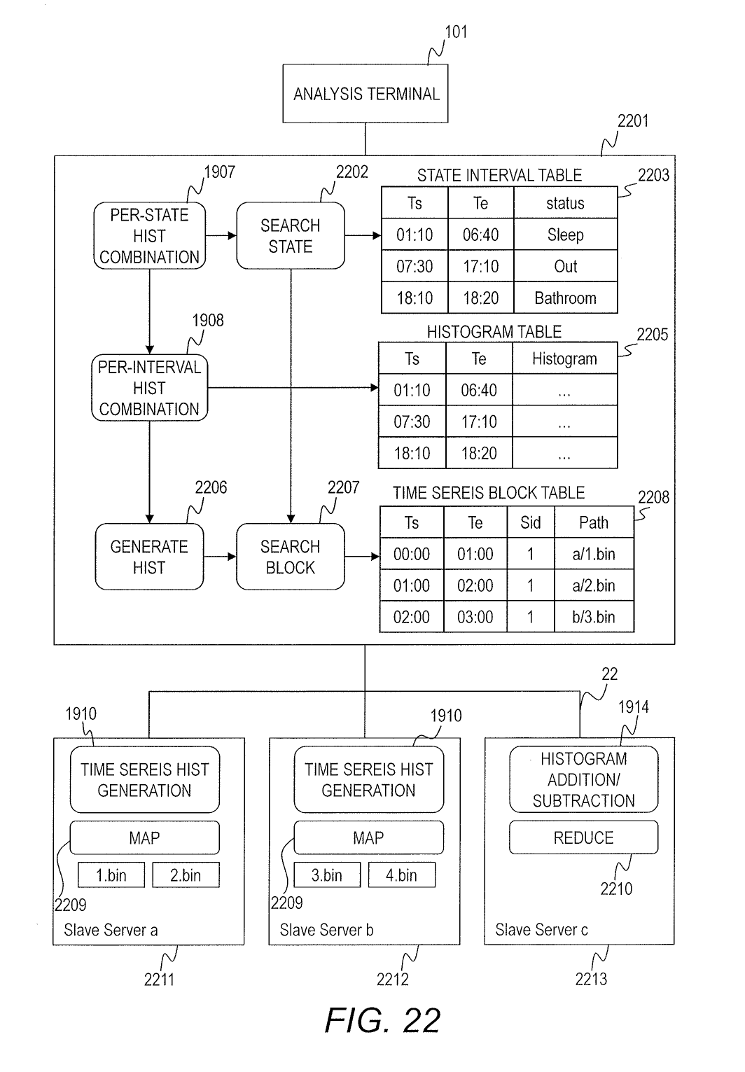

A computer system that manages a large amount of time series data 110 in a scalable manner and efficiently searches the time series data 110 by distributing and accumulating the time series data 110 across a plurality of servers will be described with reference to FIGS. 22, 23, and 24.

FIG. 22 shows Embodiment 4 of the present invention, and is a block diagram showing a configuration of a time series data analysis system that distributes and accumulates the time series data 110 across a plurality of servers.

The time series data analysis system 2201 receives queries from the analysis terminal 101 and returns results. Additionally, the time series data analysis system 2201 is coupled to a plurality of slave servers through a network 22. In the present embodiment, the time series data analysis system 2201 is coupled to a slave server a (2211), a slave server b (2212), and a slave server c (2213).

The time series data analysis system 2201 divides the primary time series data into a plurality of time series blocks, and distributes and stores the time series blocks as files on a plurality of servers. A time series block table 2208 that manages the locations of the time series blocks, a histogram table 2205 that manages partial histograms, and a state/interval table 2203 that manages associations between states and intervals are stored as tables on a relational database management system (RDBMS).

The time series data analysis system 2201 includes the time series block table 2208. The time series block table 2208 has a similar configuration to the table 502 in FIG. 5C, and stores the start time Ts, end time Te, and sensor ID=sid of the time series block; and a path “path” comprised of an identifier for the server in which the time series block is stored and the file path.

The first row of the table 2208, for example, indicates that a time series block at an interval of 0:00 to 1:00 with a sensor ID of 1 is stored in a path indicated by file name 1.bin in the slave server a.

The time series block stores, as a file, partial time series data indicated by the V column (5023) of the table 502 shown in FIG. 5C of Embodiment 1. The time series data analysis system 2201 includes the histogram table 2205. The histogram table 2205 has a similar configuration to the interval table 600 shown in FIG. 6 of Embodiment 1, and stores start times Ts, end times Te, and histograms.

The time series data analysis system 2201 includes the state/interval table 2203. The state/interval table 2203 has a similar configuration to the interval table 600 shown in FIG. 6 of Embodiment 1, and stores start times Ts, end times Te, and states “status”.

The time series data analysis system 2201 also includes a block search function 2207 for searching the time series block table 2208 and a state search function 2202 for searching the state/interval table.

The slave servers are provided with a distributed processing mechanism known as the MapReduce algorithm. The MapReduce algorithm is comprised of a Map function and a Reduce function that are stored on a plurality of slave servers, and in this algorithm, when programs operating respectively by the Map function and the Reduce function are provided from outside, a plurality of Map functions respectively receive data and execute the programs, the programs aggregate result data and provide the data to a Reduce function, the Reduce function receives aggregated data from the plurality of Map functions and executes the programs, and by issuing the results as a response a data distribution process is executed.

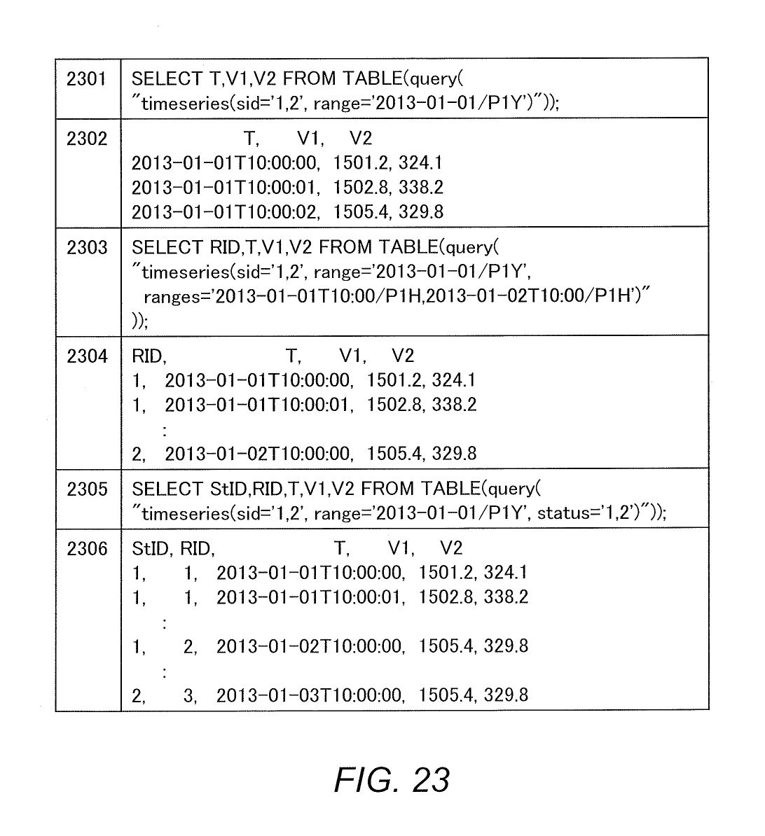

FIG. 23 shows an example of queries and response data when searching time series data. FIG. 23 shows an example of a query issued by the analysis terminal 101 in order to acquire time series data, and returned results of the query.

A query 2301 is an example of an SQL query that acquires an aggregate of designated sensor IDs and time series data in a designated interval range. In the query 2301, a table function expansion function in the FROM statement in the SQL code is used to code the chronology search query.

The code is comprised of commands and a group of arguments; the timeseries command is used to request acquisition of time series data, sid=1, 2 indicates sensor chronologies having sensor IDs of 1 and 2, and range indicates an interval of 1 year from Jan. 1, 2013 in ISO 8601 format.

The results 2302 indicate processing results for the query 2301, and a column T indicating times and columns V1 and V2 indicating measured values are outputted.

If the time series data analysis system 2201 in FIG. 22 receives the query 2301 from the analysis terminal 101, the time series data analysis system 2201 uses the block search function 2207 to acquire an interval aggregate including a requested sensor ID and a requested interval and a path aggregate of time series blocks corresponding to the intervals from the time series block table 2208, acquires a file aggregate of time series blocks from a plurality of slave servers including the slave servers 2211 and 2212, and selects time series data of the requested intervals from the time series blocks, thereby attaining results.

A query 2303 is an example of an SQL query that acquires a designated sensor ID aggregate and time series data in a designated interval aggregate. The timeseries command is used to request acquisition of time series data, sid=1, 2 indicates sensor chronologies having sensor IDs of 1 and 2, and ranges indicate two intervals including an interval of 1 hour from 10:00 on Jan. 1, 2013 and an interval of 1 hour from 10:00 on Jan. 2, 2013, in ISO 8601 format.

The results 2304 indicate processing results for the query 2303, and in addition to a column T indicating times and columns V1 and V2 indicating measured values, interval numbers RID generated in order to differentiate a plurality of intervals are outputted.

If the time series data analysis system 2201 in FIG. 22 receives the query 2303 from the analysis terminal 101, the time series data analysis system 2201 uses the block search function 2207 to acquire an interval aggregate including a requested sensor ID and a requested interval aggregate and a path aggregate of time series blocks corresponding to the interval aggregate from the time series block table 2208, acquires a file aggregate of time series blocks from a plurality of slave servers including the slave servers 2211 and 2212, and selects time series data of the requested intervals from the time series blocks, thereby attaining results.

A query 2305 is an example of an SQL query that acquires a designated sensor ID aggregate and time series data of a designated state aggregate in a designated interval aggregate. The timeseries command is used to request acquisition of time series data, sid=1, 2 indicates sensor chronologies having sensor IDs of 1 and 2, range indicates an interval of 1 year from Jan. 1, 2013, and “status” indicates states 1 and 2. The results 2306 indicate the returned results, and in addition to a column T indicating times and columns V1 and V2 indicating measured values, and interval numbers RID generated in order to differentiate a plurality of intervals, state names for differentiating a plurality of states are returned.

If the time series data analysis system 2201 in FIG. 22 receives the query 2305 from the analysis terminal 101, the time series data analysis system 2201 uses the state search function 2202 to select from the state/interval table 2203 an interval aggregate of the requested interval and the requested state, and also uses the block search function 2207 to acquire an interval aggregate including a requested sensor ID and a requested interval aggregate, and a path aggregate of time series blocks corresponding to the interval aggregate from the time series block table 2208, acquires a file aggregate of time series blocks from a plurality of slave servers including the slave servers 2211 and 2212, and selects time series data of the requested intervals from the time series blocks, thereby attaining results.

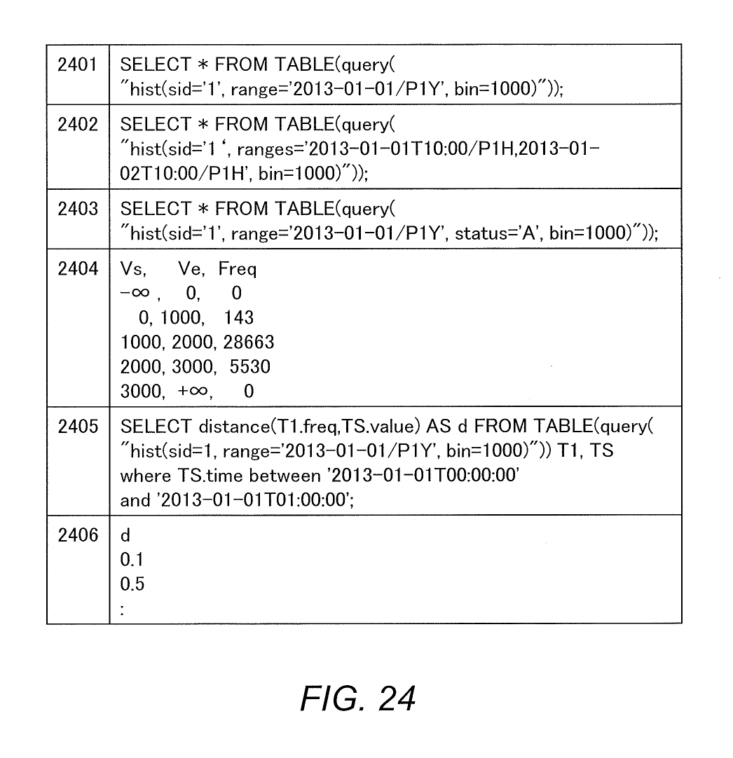

FIG. 24 shows an example of a query issued by the analysis terminal 101 in order to acquire a histogram of time series data, and returned results of the query.

A query 2401 is an example of an SQL query that acquires designated sensor IDs and a histogram of time series data 110 in a designated interval range. In the query 2401, the hist command is used to request the acquisition of a histogram of the time series data 110, sid=1 indicates a sensor chronology having a sensor ID of 1, range indicates an interval of 1 year from Jan. 1, 2013, and bin indicates the bin division width.

A query 2402 is an example of an SQL query that acquires designated sensor IDs and a histogram of time series data in a designated interval aggregate, and the arguments are similar to those of the query 2303.

A query 2403 is an example of an SQL query that acquires a designated sensor ID aggregate and a histogram of time series data of a designated state aggregate in a designated interval, and the arguments are similar to those of the query 2305.

A result 2302 indicates the response results common to the queries 2401, 2402, and 2403 and a starting range Vs and an ending range Ve of the measurement values, and a number Freq of measurement values present in the range of Vs to Ve is returned. In query 2401, bin is set as 1000, and as a result, a result 2404 is calculated with the range at intervals of 1000.

If the time series data analysis system 2201 in FIG. 22 receives the query 2401 from the analysis terminal 101, the time series data analysis system 2201 uses the per-interval histogram combination function 1908, histograms are combined by the method described in FIG. 16 of Embodiment 1 from the histogram table 2205, and if there is no histogram corresponding to the interval, a histogram is generated from the time series data in step 1602.

In Embodiment 4, the chronology histogram generation function 1910 in FIG. 19 is implemented as a program on a Map function 2209 in the plurality of slave servers 2211 and 2212, and the histogram addition/subtraction function 1914 is implemented as a program on the Reduce function 2210.

In other words, the histogram generation function 2206 acquires the path aggregate of time series blocks encompassing intervals necessary to generate histograms from the time series block table 2208, and issues a command, to generate histograms from the time series data in the time series blocks stored in the respective slave servers, to the chronology histogram generation function 1910 on the Map function 2209 on the slave servers where the time series blocks are present.

The histograms generated by the chronology histogram generation function 1910 on the slave servers are aggregated to the histogram addition/subtraction function 1914 on the Reduce function 2210, and by combining histograms, the target histogram is attained. Similarly, the queries 2402 and 2403 generate histograms for a plurality of interval aggregates and perform a process on the state aggregate in the designated interval.

The query 2405 is a singularity search query employing a histogram generation query (queries 2401, 2402, 2403). The FROM statement in the query 2405 refers to two tables T1 and TS. The first table T1 is a table function similar to the query 2401 and attains a result 2404. The second table T2 is a normal RDB table comprised of a time column indicating times and a value column indicating measurement values, and the time indicated in the WHERE statement acquires a chronology from 0:00 to 1:00 on Jan. 1, 2013.

By an embedded function distance in the SELECT statement, a singularity search is performed on the measurement values of the chronology acquired from the table TS, and the histogram, and the result thereof is returned as a result 2406.

The embedded function distance performs a process similar to the first implementation of the singularity detection function 122 disclosed in FIG. 2 and the end of Embodiment 1. That is, the embedded function distance compares a histogram attained as a result of the query 2401 with the measurement values of the search results of the table TS, and returns the frequency in the histogram of inputted measurement values as a “non-singularity”. The lower the “non-singularity” is, the more singular the inputted measurement value is. As a result, the query 2405 attains the result 2406 as a chronology of the “non-singularity”.

The effect of Embodiment 4 is that if partial histograms are present in the histogram table 2205, then it is possible to combine histograms efficiently by the method of Embodiment 1, and even if no partial histograms are present, it is possible to perform histogram generation from the time series data in a distributed manner across a plurality of slave servers, enabling an increase in efficiency of processing speed.

The computers, processing units, and processing means described related to this invention may be, for a part or all of them, implemented by dedicated hardware.

The variety of software exemplified in the embodiments can be stored in various media (for example, non-transitory storage media), such as electro-magnetic media, electronic media, and optical media and can be downloaded to a computer through communication network such as the Internet.

This invention is not limited to the foregoing embodiments but includes various modifications. For example, the foregoing embodiments have been provided to explain this invention to be easily understood; they are not limited to the configurations including all the described elements.

What is claimed is:

1. A time series data management method by which a histogram is generated from time series data in a computer that includes a processor and a storage device, the method comprising:
a first step in which the computer stores in the storage device the time series data including a time and a value;
a second step in which the computer stores in the storage device interval information including a start time, an end time, and an identifier of the time series data;
a third step in which the computer generates the histogram from the time series data corresponding to the interval information and accumulates the histogram in the storage device;
a fourth step in which the computer receives an interval to be searched; and
a fifth step in which the computer selects the histograms relating to the interval to be searched, combines the selected histograms, and generates a histogram of the interval to be searched.

2. The time series data management method according to claim 1,
wherein the third step includes:
a step of calculating a degree of similarity of the accumulated histograms;
a step of combining adjacent pieces of interval information among histograms classified as being the same with the degree of similarity being greater than or equal to a threshold;
a step of generating a histogram of time series data corresponding to the combined pieces of interval information; and
a step of accumulating the combined pieces of interval information and the histograms.

3. The time series data management method according to claim 2,
wherein in a step of combining adjacent pieces of interval information among histograms classified as being the same with the degree of similarity being greater than or equal to a threshold, adjacent pieces of interval information among histograms classified as being the same are combined for each of a plurality of prescribed thresholds.

4. The time series data management method according to claim 1,
wherein the third step includes:
a step of calculating a degree of similarity of histograms corresponding to the accumulated interval information;
a step of assigning a same state label to non-adjacent pieces of interval information that are classified as the same with the degree of similarity being greater than or equal to a prescribed threshold;
a step of generating a histogram from time series data corresponding to the pieces of interval information assigned the same state label; and
a step of accumulating the generated histogram as additional information to the state label.

5. The time series data management method according to claim 4,
wherein a step of assigning a same state label to non-adjacent pieces of interval information that are classified as the same with the degree of similarity being greater than or equal to a prescribed threshold is performed; and
wherein a same state label is assigned to non-adjacent pieces of interval information that are classified as the same for each of a plurality of prescribed thresholds.

6. The time series data management method according to claim 1,
wherein, in the fourth step,
a request accuracy threshold of the histogram is received in addition to the interval to be searched, and
wherein, in the fifth step,
when selecting the histogram relating to the interval to be searched, if a time difference between a length of the interval to be searched and an interval length of an aggregate of the accumulated histograms is less than the request accuracy threshold, then a search of the combined accumulated histograms is terminated.

7. The time series data management method according to claim 1,
wherein the third step includes:
a step of calculating a degree of similarity of the accumulated histograms;
a step of dividing interval information among histograms classified as not being the same with the degree of similarity being greater than or equal to a threshold;
a step of generating a histogram of time series data corresponding to the divided pieces of interval information; and
a step of accumulating the divided pieces of interval information and the histograms.

8. The time series data management method according to claim 1,
wherein the third step includes:
a step of calculating a degree of similarity of the accumulated histograms;
a step of assigning a same aggregate label as additional information to the time series data corresponding to histograms that have been classified as being the same with the degree of similarity being greater than or equal to a threshold;
a step of generating a histogram from time series data assigned the same aggregate label; and
a step of accumulating the aggregate label and the histograms.

9. The time series data management method according to claim 1,
wherein the third step includes:
a step of calculating a degree of similarity of the accumulated histograms;
a step of clustering the time series data corresponding to the histograms according to the degree of similarity to divide the time series data into small aggregates;
a step of generating a histogram from all time series data belonging to the small aggregates of the time series data; and
a step of accumulating the small aggregates of the time series data and the histograms.

10. A time series data management method by which a histogram is generated from time series data in a computer that includes a processor and a storage device, the method comprising:
a first step in which the computer divides the time series data including time and a value into time series blocks of a prescribed interval;
a second step in which the computer accumulates the divided time series blocks;
a third step in which the computer generates the histogram from the time series data corresponding to the time series blocks and accumulates the histogram in the storage device;
a fourth step in which the computer receives an interval to be searched;
a fifth step in which the computer searches the time series blocks including the interval to be searched; and
a sixth step in which the computer selects the histograms relating to the interval to be searched in the searched time series block, combines the selected histograms, and generates a histogram of the interval to be searched.

11. A time series data management system by which a histogram is generated from time series data in a computer that includes a processor and a storage device,
wherein the computer
stores in the storage device the time series data including time and a value, and interval information including a start time, an end time, and an identifier of the time series data;
generates the histogram from the time series data corresponding to the interval information and accumulates the histogram in the storage device; and
receives an interval to be searched, selects the histograms relating to the interval to be searched, combines the selected histograms, and generates a histogram of the interval to be searched.
